(19) United States
(12) Patent Application Publication
(10) Pub. No.: US 2013/0290707 A1
(43) Pub. Date: Oct. 31, 2013

(54) INFORMATION DISTRIBUTION SYSTEM

(71) Applicant: CARPADIUM CONSULTING PTY. LTD., North Sydney (AU)

(72) Inventors: Matthew Frazer Sinclair, McMahons Point (AU); Andrew Randle McDonald, Freshwater (AU); Benjamin Roy Forrest, Manly East (AU)

(21) Appl. No.: 13/844,348

(22) Filed: Mar. 15, 2013

Related U.S. Application Data
(63) Continuation-in-part of application No. 13/022,457, filed on Feb. 7, 2011.

(51) Int. Cl. H04L 9/08

(52) U.S. Cl. CPC H04L 9/0891
USPC 713/161

(57) ABSTRACT

A data delivery system is disclosed in this specification. The system implements an authentication process that verifies data recipients using anonymised geospatial references. Verifying information for each user is stored in client accounts. A server system uses the information to process data requests and generate verification tags for data deliveries. The verification tags include an irreversible encoding of a delivery reference for receipt of a data delivery. Recipient client systems implement a compatible encoding process to generate a delivery authentication tag. The encoded authentication tags are compared to corresponding verification tags to validate data deliveries based on the location of the client system.

### FIELD OF THE INVENTION

The present invention relates to a system and method for distributing information across a network, and more particularly to a method and system for authenticating the recipient of the information.

### BACKGROUND OF THE INVENTION

Publically accessible digital networks (such as the internet and cellular networks) are a primary link in contemporary information distribution. Most practical digital distribution networks are exposed to security threats because they exploit widespread publically accessible communication infrastructure to distribute information. The underlying infrastructure enables information to be distributed to a significant portion of the general population at the expense of compromised security. Sensitive information (such as pin numbers or passwords) is often not transmitted digitally because of perceived exposure to security threats.

### SUMMARY OF THE INVENTION

In a first aspect, the present invention provides a data delivery method comprising:

receiving a delivery request from a client system, the request including a client account identifier,

retrieving a registered delivery location for a corresponding client account, the delivery location prescribing a geospatial position for recipient verification,

deriving a geospatial delivery reference from the delivery location, the geospatial delivery reference defining a bounding area that contains the delivery location,

generating a delivery verification tag from the geospatial delivery reference, the verification tag being an irreversible encoding of the geospatial delivery reference, and

assembling a data delivery parcel comprising an encrypted data package and a delivery verification tag.

In a second aspect, the present invention provides a verification process comprising:

obtaining a registered data parcel comprising an encrypted package and a verification tag,

determining the geospatial location of a client system registered to the data parcel,

deriving a geospatial reference from the client system location, the geospatial reference defining a bounding area that contains the determined location of the client system,

generating a recipient authentication tag from the geospatial reference, the authentication tag being an irreversible encoding of the geospatial reference,

determining a correlation factor between the recipient authentication tag generated for the client system and the verification tag incorporated in the data parcel, and

decrypting the encrypted package when the correlation factor indicates the client system is within a defined proximity of a registered delivery location.

In a third aspect, the present invention provides a data delivery system comprising:

a distribution server that maintains client accounts for a data distribution network and interfaces with a plurality of client systems, each of the client accounts being linked to a client system and a registered delivery location,

a registration module that derives geospatial delivery references from the delivery locations linked to individual client accounts, the geospatial delivery references defining a bounding area that contains a corresponding delivery location,

a reference module that generates verification tags for data deliveries, each of the verification tags being irreversibly encoded from the geospatial delivery reference derived for a target client account, and

a communications module that assembles data parcels for distribution to client systems within the distribution network, each data parcel comprising an encrypted data package and a delivery verification tag for a corresponding client account.

In a fourth aspect, the present invention provides a recipient verification method comprising comparing an irreversibly encoded geospatial decryption reference accompanying a digital delivery to a current recipient system location irreversibly encoded using a compatible encoding process to verify the recipient system before releasing an encrypted data package.

In a fifth aspect, the present invention provides an authentication method comprising:

obtaining a geospatial location of a verifying party computing system, the geospatial location representing a claimed verifying party location,

deriving a geospatial reference from the geospatial location, the geospatial reference defining a bounding area that contains the geospatial location,

encrypting the geospatial reference using a computing system processor to generate anonymized verification data using a one-way function, and

comparing the anonymized verification data with authentication data generated from an authenticated geospatial reference to authenticate the verifying party.

In a sixth aspect, the present invention provides an authentication system comprising:

a server that facilitates authentication of verifying parties, the server being connected to a data network,

a plurality of user accounts stored in server memory and accessible through the data network, the user accounts including verifying party accounts that store an identifier for a registered verifying party system and relying party accounts that store an identifier for a corresponding relying party,

a transaction interface that receives authentication requests from verifying parties and links the verifying party account associated with each of the requests to a relying party account, and

a validation module that compares anonymized hash data received from parties involved in a transaction, the hash data being irreversibly derived from a verifying party location and an authenticated location stored on a corresponding relying party system.

In a seventh aspect, the present invention provides an authentication method comprising:

receiving a request to authenticate a party involved in a transaction over a data network, the request being issued by a verifying party system,

generating a dedicated salt value for the transaction using a computing system processor and distributing the dedicated salt value to the verifying party and a corresponding relying party over a data network,

receiving anonymized hash data from the respective parties, the hash data being irreversibly derived from the location of the verifying party and an authenticated location stored on a corresponding relying party system, and comparing the anonymized hash data to determine whether the verifying party system is proximate the authenticated location.

The foregoing summary is illustrative only and is not intended to be in any way limiting. In addition to the illustrative aspects, embodiments, and features described in the summary, further aspects, embodiments and features will become apparent by reference to the drawings and the following detailed description.

In an eighth aspect, the present invention provides an authentication method comprising:

obtaining display co-ordinates for the presentation of data on a computing system interface, the display co-ordinates defining the position of the data on the interface,

displaying a block image on a continuous section of a computing system interface that encompasses the position defined by the display co-ordinates, the block image representing a virtual panel that obscures underlying data,

receiving user input that coincides with the position of the data defined by the display co-ordinates and removing sections of the block image from the computing system interface that coincide with the received user input, and

displaying portions of the data that coincide with the removed sections of the block image to give the impression of the data being revealed from underneath the panel by the user input.

### BRIEF DESCRIPTION OF THE DRAWINGS

Features and advantages of the present invention will become apparent from the following description of embodiments thereof, by way of example only, with reference to the accompanying drawings, in which;

FIG. 1 is a schematic diagram showing a generalised apparatus in accordance with embodiments of the present invention, together forming a system in accordance with an embodiment of the present invention;

FIG. 2 is a diagram illustrating operation of a location anonymising process in accordance with an embodiment of the present invention;

FIG. 3 is a further diagram illustrating operation of the anonymising process;

FIG. 4 is a diagram illustrating operation of the anonymising process of this embodiment on actual locations;

FIG. 5 is a schematic diagram of a system in accordance with an embodiment of the present invention;

FIG. 6 is a process diagram of authentication in accordance with an embodiment of the present invention;

FIGS. 7 and 8 are example screen displays which may be generated by relying parties, in accordance with embodiments of the present invention;

FIGS. 9 and 10 are example screen displays which may be generated by an authenticating system in accordance with an embodiment of the present invention;

FIGS. 11 through 14 are example displays of a mobile device for a verifying party, in accordance with an embodiment of the present invention;

FIGS. 15 to 17 are example displays which may be provided by an authenticating system in accordance with an embodiment of the present invention;

FIGS. 18 through 22 are example displays for a mobile device for a verifying party, in accordance with an embodiment of the present invention;

FIGS. 23 through 28 are process diagrams for authentication processes in accordance with example applications of embodiments of the present invention;

FIGS. 29 and 30 are diagrams illustrating aspects of anonymising processes in accordance with embodiments of the present invention, and

FIG. 31 is an example display which may be provided by an authenticating system in accordance with an embodiment of the present invention.

FIG. 32 is a schematic representation of an information distribution network incorporating an authentication system.

FIG. 33 is a schematic representation of an information exchange between a client system and a distribution server involving a client verification protocol.

FIG. 34 is a flow chart representation of a secure method of distributing sensitive information between an account server and a client system.

FIG. 35 is a schematic representation of a registration process initiated by a client system.

FIG. 36a is a screenshot from the user interface of a client system depicting a notification screen.

FIG. 36b is a screenshot from the user interface of a client system depicting a request verification screen.

FIG. 36c is a screenshot from the user interface of a client system depicting a notification screen.

FIG. 36d is a screenshot from the user interface of a client system depicting a location screen.

FIG. 36e is a screenshot from the user interface of a client system depicting a location confirmation screen.

FIG. 37a is a screenshot from the user interface of a client system depicting a history screen.

FIG. 37b is a screenshot from the user interface of a client system depicting a settings screen.

FIG. 38a is a screenshot from the user interface of a client system depicting another request verification screen.

FIG. 38b is a screenshot from the user interface of a client system depicting a virtual scratch panel.

FIG. 38c is a screenshot from the user interface of a client system depicting the virtual scratch panel of claim 38b with sections of the panel removed to reveal underlying information.

### DETAILED DESCRIPTION OF EMBODIMENTS

Embodiments and applications of an authentication method and process in accordance with the present invention will now be described. In the following embodiments, location is used for the purposes of authentication. Location of a party (the “verifying party”) may be used as a sole indicator for authentication, or may be used in addition to one or more other indicators (second factor authentication). Other indicators may include any identifier, such as a password, biometric, credit card, or any other identifier.

The use of location for authentication purposes will be referred to in this document as “geodetic authentication”. Geodetic authentication may be used for “geodetic transactions”, where implementation of a transaction (e.g. web purchase, bank account transfer, or any other transaction) depends on geodetic authentication.

In embodiments of the present invention, verified location data of a verifying party may be obtained by use of a device which is able to obtain a user's physical location in space. Many such devices are now known, and include many mobile computing devices which include a communications interface. Devices include mobile telephones, Smartphones, tablet computers and many other mobile communications devices. They also include portable computing devices (PDAs), laptop computers and personal computers. Any device which can obtain location information can be utilised to obtain verified location data for use in embodiments of the present invention.

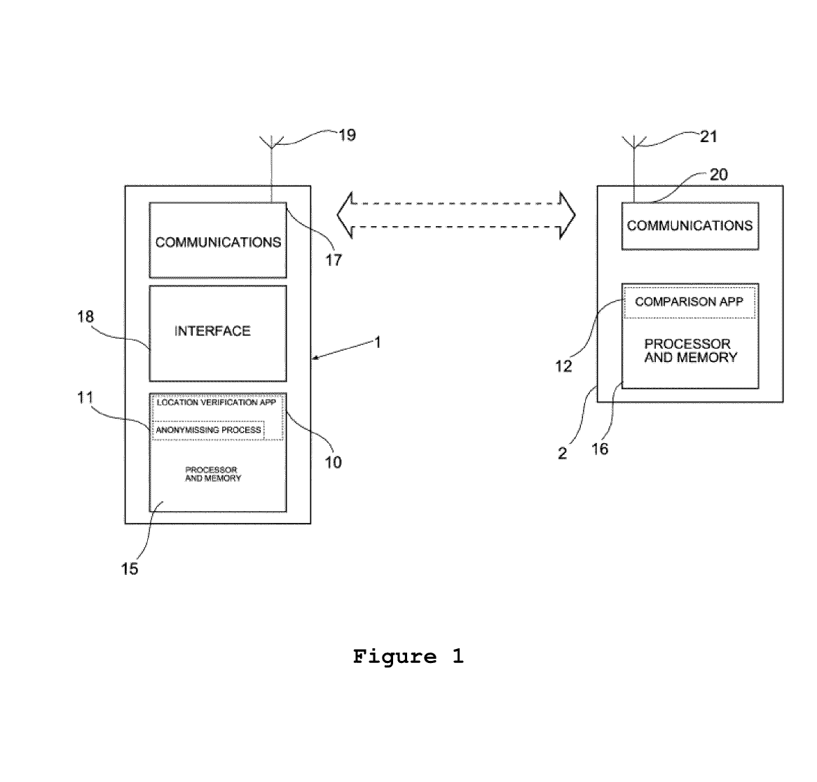

FIG. 1 is a schematic diagram of a generalised mobile device which may be utilised to implement the present invention. The generalised mobile device is indicated generally by reference numeral 1 and comprises a location verification application 10 which is arranged to obtain verified location data of a verifying party requiring authentication. The verifying party requiring authentication is usually a person associated with the device 1, e.g. the user of the mobile device.

In this embodiment, the location verification application is arranged to obtain verified location data which is associated with an actual physical location of the device 1 (and therefore, by proxy, of the user of the device), but which does not reveal the actual physical location. In this embodiment, the location verification application 10 comprises an anonymising process 11 which is arranged to anonymise actual physical location data identifying the actual physical location, in order to conceal the actual physical location. The verified location data provided therefore avoids identifying the actual physical location of the verifying party. In this document, the anonymising of the data is termed “privacy respecting proximity”, or “PRP”.

The device 1 is arranged to transmit the verified location data (the anonymised data, in this embodiment) to a comparison apparatus 2, which comprises a comparison application 12 arranged to compare the verified location data with claimed location data in order to authenticate the verifying party on the basis of the comparison.

The comparison apparatus may be any device which is capable of carrying out the comparison and, in an embodiment, is a computing device, such as a server computing system, stand alone PC, or any computing device. In an embodiment, the device could be another mobile computing device, such as device 1.

In an embodiment, the comparison apparatus 2 may be associated with an independent authenticating party remote from the verifying party, and arranged to provide authentication based on the verified location data. The claimed location data may be any location data that the verified location data is being compared against for authentication purposes. In an embodiment, the claimed location data may be provided to the comparison apparatus 2 by another party who is relying on the authentication, in this document known as the “relying party”.

The relying party may be any person needing to authenticate the verifying party, for example for purposes of completing a transaction. In embodiments, the relying party may be a merchant wishing to confirm sale of a product (goods and/or services); financial institution wishing to authenticate a verifying party to allow an account transfer, access to an account, or other transaction; a security entity wishing to authenticate the verifying party for access to a location or access to a secure system (e.g. secure computing system); another person associated with another mobile device 1, and wishing to obtain some authentication of the verifying party (e.g. a social network user who wishes to connect to the verifying party on the social network, and first wishes to obtain some trust in the verifying party); a service provider wishing to provide a service and requiring authentication for the service (e.g. an email provider wishing to provide web mail access to the verifying party), and many other applications.

In more detail, the device 1 comprises a processor and memory 15 which may be of any known architecture. The location verification application may comprise a computer program loaded onto the processor and memory of the device 1. The location verification application may be written in any appropriate computer language in order to interface with the processor and memory 15. It will be appreciated that the location verification application is not limited to being implemented in computer software on a processor, but may be implemented in other ways (e.g. implemented as a programmable gate array (PGA) or field programmable gate array (FPGA)), firmware, or in any other way). Location verification application and processor memory 15 architecture will depend on the particular type/brand of device. As will be appreciated, there are many such mobile communications devices now available with which an appropriately configured location verification application may be interfaced.

Similarly, the comparison application 12 may be written in any type of software/computer code compatible with the processor and memory 16 of the comparison apparatus 2. The comparison application 12 is not limited to being a computer software module, but may also be implemented by PGA or FPGA or in any other way.

The processor and memory 15 may also include other functionality required for the operation of the device 1, which may also be in the form of programs, firmware, or in other form. In this embodiment, the device 1 is capable of obtaining physical location information in the form of physical location data, such as GPS. The processer and memory 15 have the appropriate functionality to do this, and may interact via communications 17 with a remote service to obtain the location information. Such services are well-known and many such devices are available which have, for example, a GPS functionality. Note that devices are known which use different mechanisms for acquiring location information. For example, some devices use a combination of cell tower triangulation, GPS coordinates and WiFi access point location (depending on availability). Some devices use one only of these. Some devices use all of these in combination or selectively. In this embodiment, how the location information is obtained by the apparatus is irrelevant. The location verification application is agnostic to how the physical location data is obtained.

The processor and memory 15 may also provide other functions, such as voice, data processing, etc.

The device 1 also includes an interface 18 enabling the user (verifying party) to interact with the device. The interface may include any known components, such as keypad, touch screen, display, microphone, camera, loudspeaker, and other known interface devices.

Communication circuitry 17 is also provided enabling communications by known communications networks, including wireless networks via antenna 19.

Comparison apparatus 2 also comprises appropriate communications circuitry 20, 21 enabling communication with device 1 and other devices.

The comparison apparatus 2 and the mobile device 1 are shown in FIG. 1 as generalised devices. It will be appreciated that the architecture may vary. The main functionality for the purposes of the present invention relates to obtaining the verified location data (privacy respecting proximity) and comparison. This functionality (as described in more detail later on) may be implemented by any type of suitable processing device.

The use of location as a factor in authentication has a number of advantages. With the availability of devices able to easily and cost effectively establish location, location as an authentication factor is relatively accessible. It can also be relatively inexpensive as compared with other methods of authorisation (e.g. biometrics, SMS). Location can be easily established by virtue of GPS, cell tower triangulation, WiFi access point location and other methods. In terms of price, the location authentication process relies on a physical device (e.g. device 1) which is already in the hands of the user. It can also use a communications mechanism that incurs no per transaction costs for the authenticator or user. This creates an authentication platform that is effectively, in some embodiments, free to use for end-users, with very low (or even zero) fixed costs to authenticators. This is in contrast to SMS, which costs money for each SMS sent, or physical one-time password tokens (aka “key fobs”) that have a real device cost to provision to end users (which ultimately end up amortised as per transaction costs).

Location can be utilised in a number of ways. It can determine the location that a verifying person is at (IS AT). It can determine the location that the verifying party is near (IS NEAR). It can also be used to confirm whether one verifying party is near another user. It can also be used to check if a group of users are co-located.

In other embodiments, as will be discussed in more detail later, location can also be used to determine where a verifying party was at a particular time (WAS AT) or whether a verifying party or a group of users were near a place (WAS NEAR) or were near each other (WAS AT NEAR). Such geodetic authentication can therefore be used in a number of different ways, and can also be used to operate as second factor authorisation, relatively cheaply and relatively securely. As discussed above, although using location as an authentication factor is a valuable addition to different authentication and authorisation scenarios, introducing precise data about location can reveal information about a person that is not relevant and could seriously diminish individual privacy. This is a problem that can be exacerbated when transactions involve more than two participants, as it presents additional opportunities for the leakage of personal identifying information, such as physical position.

For example, consider a scenario where it is necessary to verify that individuals are located in close proximity to one another. It is not necessary to know their specific location, but simply that they are near each other by some measure, such as within a 100 metre radius. If specific locations in the form of latitude and longitude coordinates are used to calculate their proximity, there is a risk that this information could fall into the wrong hands at some point in the future, or be used in a manner not explicitly authorised by the participants. This risk might act as a deterrent to the parties to use a service with these location-aware features.

As a general principle, authorisation systems, whether for payments or identity, should not capture or expose any more information than is strictly necessary and mutually agreed by all parties. In particular, the utmost respect should be given for privacy of the personally identifying information of all parties.

Location and proximity can be used in a number of different ways in transactions in accordance with embodiments of the present invention. Firstly, it is possible to query a user's current location and verify that it is the same as some previously known location. Secondly, it is possible to check the current locations of one or more users and verify that they are near each other. And finally, it is possible to use the first two mechanisms in combination to check if a group is near a known location.

These actions can be represented as the three operations:
IS-AT: is a person at or near a known location?
IS-NEAR: is a person next to another person?
IS-AT-NEAR: is a person at or near a known location and near one or more other people?

In the case of IS-AT, the party asking the question obviously knows the location in question, as does the target, but it is useful to ensure that details of this location are not leaked to any 3^{rd}-parties. In the case of IS-NEAR, the absolute location of both parties is irrelevant, but their relative proximity is important. IS-AT-NEAR has the same properties as IS-AT, in that the specific location is important, but it is important not to leave an electronic trail unnecessarily accessible by 3^{rd}-parties.

Preventing leakage of privacy information is even more important in the WAS-AT and WAS-NEAR operations. By definition, these operations must store some information about location for later recall. Unless measures are taken to obscure specific address information, there are very real issues with privacy information leakage.

In accordance with an embodiment of the present invention, the location verification application 10 comprises an anonymising process 11 which is arranged to provide verified location data which does not reveal an actual physical location of the verifying party. The anonymising process operates to conceal the actual physical location. The anonymising process may be a software application (alternatively it may be implemented in firmware or in another manner) and in this embodiment is a module of the location verification application. In this embodiment, the anonymising process implements a step of transforming the actual physical location data to transformed location data, which is associated with the actual physical location data, but from which the actual physical location data cannot be obtained. This protects the privacy of the location. In this embodiment, the anonymising process is not reversible. The actual physical location data cannot be obtained from the transformed location data. In one embodiment, the transformed location data may be a coordinate in realspace which is associated with the actual physical location, but is not the same as the actual physical location. It may be spaced apart from it.

In this embodiment, the anonymising process comprises the step of dissolving the actual physical location data to data of a lower resolution value. For example, if the data is a latitude and longitude coordinate, it is first decimalised and then digits are rounded up or rounded down to the appropriate resolution. The rounded up/rounded down coordinate data is utilised to produce a plurality of coordinates delimiting the general location, in this embodiment in the form of a bounding area, which the actual physical location falls within the bounds of or is proximate to.

An encryption operation is then carried out on the coordinates before transmission. It is the encrypted coordinates of the general location that are transmitted and which are also used for comparison. The location is therefore fully anonymised. In an embodiment (see later), encryption is accomplished by use of a relying-party specific, per transaction salt value that is calculated based on the public key of the device used to create the verified location data.

A similar transformation is performed on actual claimed physical location data to produce the claimed location data. It is this claimed location data that is used for comparison with the verified location data. In this embodiment, therefore, what is compared are a plurality of encrypted data items, representing coordinates of a general location. The actual physical location (verified or claimed) cannot be obtained.

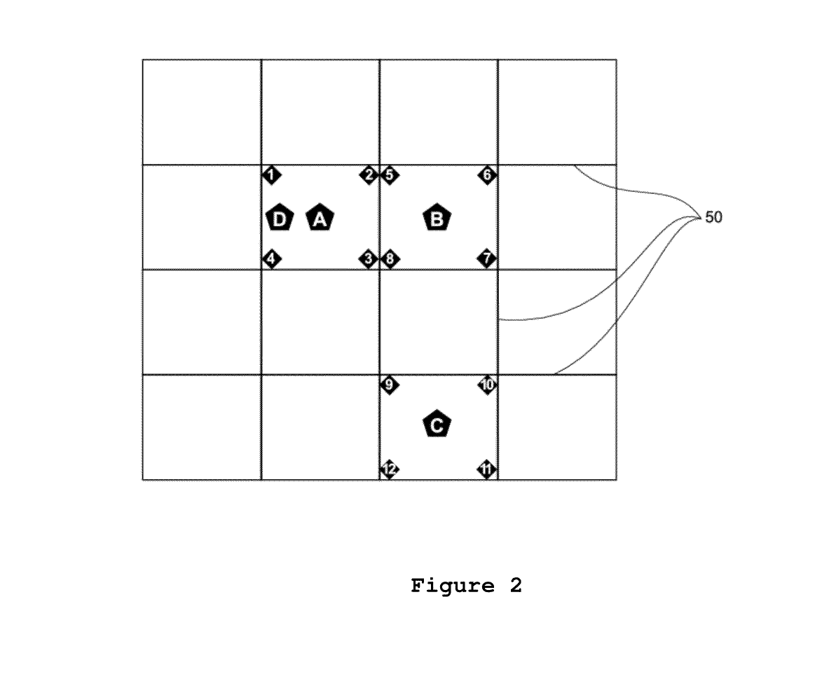

One anonymising process implemented in this embodiment of the present invention will now be described in detail, with reference to FIGS. 2, 3 and 4.

The privacy respecting proximity (PRP) protocol implemented using the anonymising process in this embodiment involves:
Converting a geographic location into a bounding box such that all points within the coordinates of the bounding box resolve to the same corner values,
Ensuring that the coordinates of the bounding box are encrypted in a per-transaction manner so that they do not reveal actual location data to any third party, and
Comparing anonymised points in terms of their relative proximity.

FIG. 2 illustrates actual physical locations superimposed on a grid comprising a plurality of bounding boxes (defined by lines 50). The points A, B, C and D represent real physical locations falling within the bounding boxes.

Consider the points A, B, C and D. The corners [1,2,3,4] represent a bounding box that encloses points A and D. The corners [5,6,7,8] enclose the point B, and corners [9,10,11,12] enclose point C.

Using the convention described above, the points A and D are within the same bounding box, and so are considered completely proximate. Points A and B (and D and B as well) are next to each other because they share a pair of corners (2,5 and 3,8). Because point C shares no common corners with any of the other points, it is not proximate with any of them.

If the comparison application 12 of device 2 were comparing the locations of A, B, C and D in accordance with the present invention, it would not be the actual physical location data which is compared, but the coordinates defining the bounding boxes which the points A, B, C and D fall within. This means that the actual physical locations cannot be identified.

Further anonymisation of the location data is carried out by encrypting (by hashing using a SALT) each of the coordinates of the bounding boxes before transmission.

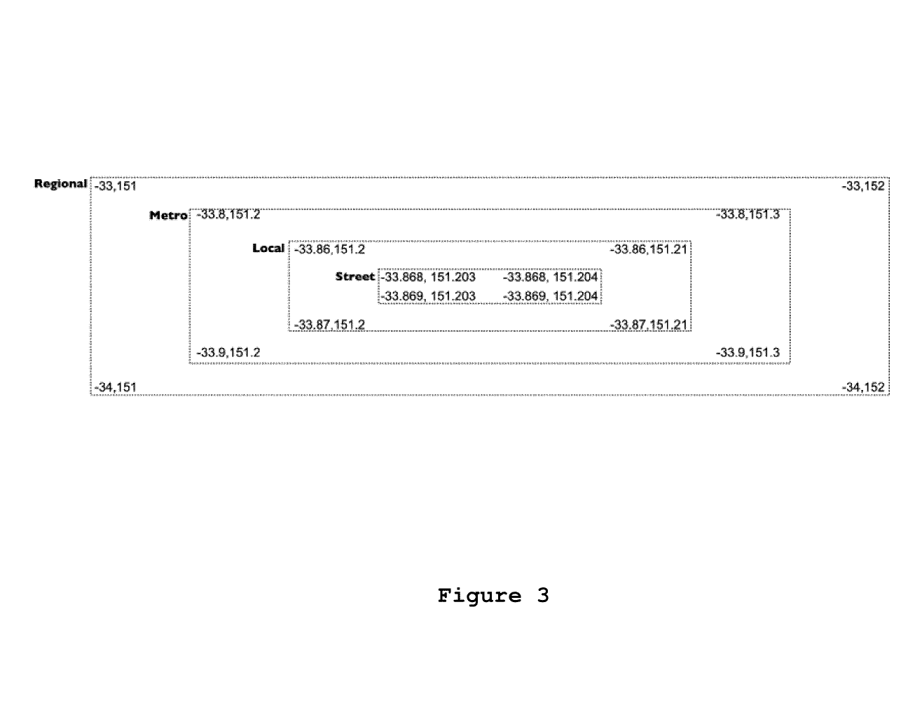

FIG. 3 illustrates a bounding box location for different bounding box areas for real latitude and longitude spatial locations.

Four different generalisations are applied here as example, being Street, Local, City, Regional. Any choice of bounding box area may be made, depending upon the application. For example, bounding box area may be large enough to cover countries (for many problems with credit card, it would be enough to know that the credit card is within the appropriate country, for a transaction to go ahead).

The following describes calculations for the four resolutions, and their relationships to degrees/minutes/sections values:

PRP Hash Bounding Box Method #1 -
Decimal Truncation of Lat/Lng Values

| | Dec | Deg | Min | Sec | Dec |
|---|---|---|---|---|---|
| Lat | −33.868321 | −33.0 | −52.0 | −6.0 | −33.868321 |
| Lng | 151.203805 | 151.0 | 12.0 | 13.7 | 151.203805 |
| Street | 0.000 | 3.0 signfiicant digits | | | |
| Local | 0.00 | 2.0 signfiicant digits | | | |
| City | 0.0 | 1.0 signfiicant digits | | | |
| Regional | 0 | 0.0 signfiicant digits | | | |
| Street | | | | | |
| Lat | −33.868000 | −33.0 | −52.0 | −4.8 | −33.868000 |
| Lng | 151.203000 | 151.0 | 12.0 | 10.8 | 151.203000 |
| Local | | | | | |
| Lat | −33.860000 | −33.0 | −51.0 | −36.0 | −33.860000 |
| Lng | 151.200000 | 151.0 | 11.0 | 60.0 | 151.200000 |
| Metro | | | | | |
| Lat | −33.800000 | −33.0 | −47.0 | −60.0 | −33.800000 |
| Lng | 151.200000 | 151.0 | 11.0 | 60.0 | 151.200000 |
| Regional | | | | | |
| Lat | −33.000000 | −33.0 | 0.0 | 0.0 | −33.000000 |
| Lng | 151.000000 | 151.0 | 0.0 | 0.0 | 151.000000 |

### Conversion

The following algorithms may be implemented to provide a mechanism to go to and from degrees/minute/seconds and decimal degrees:
From Decimal Degrees into Degrees/Minutes/Seconds
The whole units of degrees will remain the same (i.e. in 121.135° longitude, start with 121°).
Multiply the decimal by 60 (i.e. 0.135*60=8.1).
The whole number becomes the minutes (8′).
Take the remaining decimal and multiply by 60 (i.e. 0.1*60=6).
The resulting number becomes the seconds (6″). Seconds can remain as a decimal.
Take the three sets of numbers and put them together, using the symbols for degrees (°), minutes (′), and seconds (″) (i.e. 121° 8′6″ longitude)

### Eg:

121.84305=121°+(0.84305*60)′+(0.583*60)=121° 50′35″
   From Degrees/Minutes/Seconds into Decimal Degrees
The whole units of degrees will remain the same (i.e. in 121.135° longitude, start with 121.0°).
Multiply the number of minutes by (1/60).
Multiply the number of seconds by (1/60*1/60).
Add the three numbers together to get a number in decimal degrees

### Eg:

121° 50′35″=121+(50*1/60)+(35*1/60*1/60)=121.84305

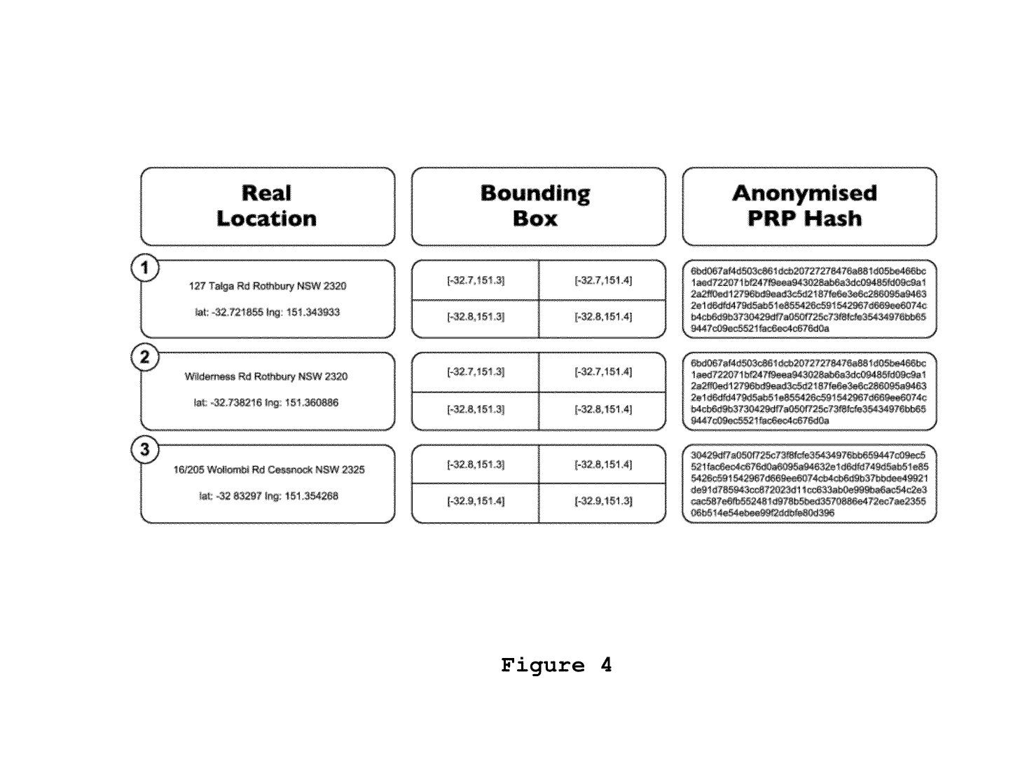

FIG. 4 gives several examples of real locations having the anonymising process applied to them. The result is a PRP Hash which conceals the real physical locations.

Locations #1 and #2 fall within the same bounding box, and so resolve to the same anonymised PRP location hash. Location #3 is far enough away from locations #1 and #2 that it resolves to a different set of bounding box coordinates, and therefore generates a completely different anonymised PRP location hash. The PRP hash is calculated with a standard hashing algorithm (e.g. SHA256, SHA512, etc) that uses a per-transaction salt value (not retained) to generate a 256 character string. The PRP hash is comprised of 4 pairs of 32 character strings (8 in total) that represent the hashed [lat,lng] pairs for each corner of the bounding box. Two points are considered proximate if one, two or four of the hashed parameters have the same hash values. The use of a per-transaction salt renders brute force attacks difficult, and ensures that there is no obvious or computationally inexpensive way to discover the original co-ordinates from the hash.

The same salt value is provided to encrypt the claimed location data as the verified location data. In this embodiment, the salt value is provided by the apparatus 2 to all parties involved in an authentication process. This occurs per transaction, so even if the salt could be cracked (which would be very difficult) it cannot be used to decrypt any other PRP hash values.

The actual physical location itself is completely protected, apart from the fact that it falls within the general area provided by the coordinates. It will be appreciated that if the general area is large enough, it is not possible to meaningfully obtain the actual physical location of the party, even if it were possible to attack the hashing of the coordinate values (which would be extremely difficult).

As illustrated above, differing scales of bounding boxes can be use for matching claimed and verified locations. The examples given above are Street, Local, Metro, City, and Regional (may accord to State or Country). Any resolution can be applied.

In embodiments, the comparison need not merely be a simple match or no-match comparison, but can also give degrees of proximity. This proximity can be refined by varying the scale of the grid (e.g. Street, Locale, Metro, City, Regional, etc). If comparing locations at the finest granularity, then an assessment can be made about how far apart the points are. Matching at the middle granularity can make a more general statement and so on. Having a less fine granularity (larger bounding box) can also be useful when accuracy of obtaining the physical location is not good because of the technology involved e.g. GPS accuracy.

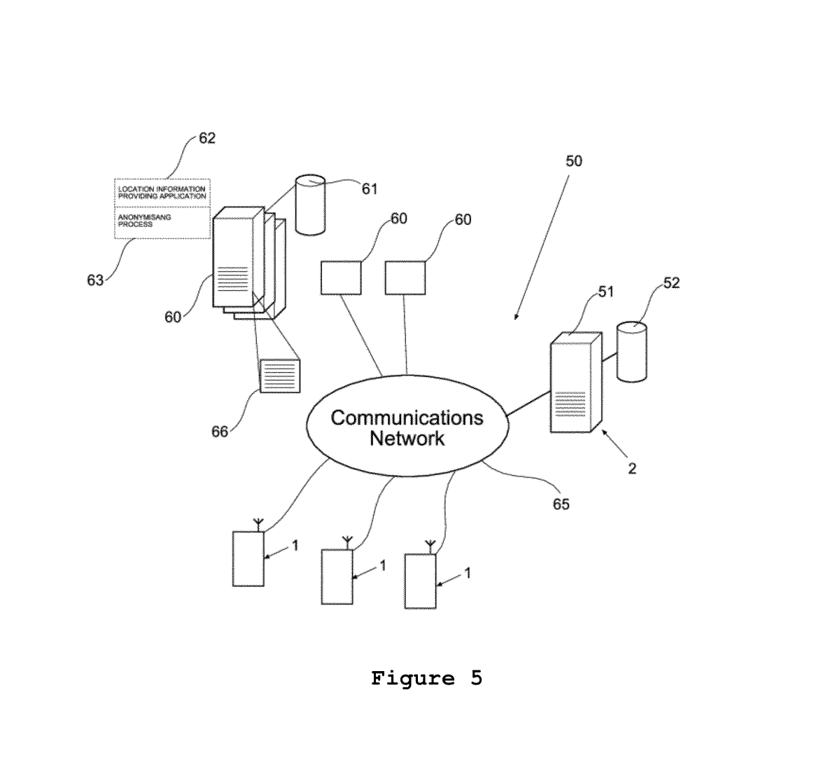

FIG. 5 illustrates a system in accordance with an embodiment of the present invention generally designated by reference numeral 50, for implementing types of transactions utilising location for purposes of authentication. The system comprises at least one location verification apparatus 1, in accordance with FIG. 1 described above. As discussed above, this may comprise any type of mobile device with the appropriate functionality for implementing this embodiment. Three devices 1 are illustrated in FIG. 5. It will be appreciated that the system may comprise one device or many devices. Three devices 1 are shown for illustrative purposes only.

In this embodiment, the comparison apparatus 2 comprises one or more server computers 51, each having a processor, and storage comprising a database 52 and other components such as buses, communications circuitry and other components required to implement the functionality described. There may be one or more server computers 51, of any known architecture. Note that the comparison apparatus 2 may be implemented by any known architecture, including server client, terminal/mainframe, cloud based or any other known architecture.

In this embodiment, comparison apparatus 2 operates as an independent authenticating party unrelated either to the verifying party or relying party, and remote from them.

In the following description and in the drawings, the authenticating party is referred to as “TouchPass”. It will be appreciated that this reference is a trade name only and the invention is not limited to the term “TouchPass”.

Further, in the following diagrams, where various example displays are shown, it will be appreciated that any trade mark material or any “touch and feel” of the display information is not limiting to the invention. Embodiments of the invention can be applied with any trade name or any look and feel implementing the functionality described in this document.

The system illustrated in FIG. 5 also comprises a relying party apparatus 60. The relying party is the party requiring authentication of the verifying party to allow a transaction to proceed. FIG. 5 illustrates the relying party apparatus in this embodiment as comprising one or more server computers 60 including a processor, and storage for a database 61. In this embodiment, relying party 60 may be an on-line merchant, or an Internet banking system, for example or any other relying party. The computing system 60 is arranged to serve web pages 66 or web services 66, in an understood manner.

A location information providing application 62 is loaded onto the relying party apparatus 60. This application 62 may be downloaded to the apparatus 60 during a registration process (see later) in the form of a plug in, for example. It may comprise appropriate software arranged to be run by the hardware and operating system of the computing system 60. The location information providing application 62 is not limited to software, however, it may be implemented in any other way, such as by FPGA or PGA, other firmware, for example.

The location information providing application system 62 comprises an anonymising process 63, which operates in a similar fashion to the anonymising process 11 of device 1, to anonymise location data. In this embodiment, the location data anonymised by anonymising process 63 is claimed location data. This is location data provided for comparison with the verified location data being provided by device 1. It is anonymised in accordance with the process discussed above in relation to FIGS. 2 to 4.

Claimed location data may be any location data which is to be compared against the verified location data to authorise the verifying party. It may be data provided by the verifying party for purposes of the transaction, such as a home address, a delivery address, a location where the verifying party is at or is near, or any other location data provided by the verifying party. Alternatively or additionally, it may be location data already known to the relying party, such as the position of a point of sale device, an EFT device, an ATM, or any other known location information. The claimed location information will in part depend upon the type of transaction.

The location verification apparatus 60 is not limited to server computer architecture, but may be any computing device, including a PC, a mobile device or the like capable of supporting the location information providing application 62. Where it is involved in a merchant type transaction or financial institution transaction and must serve webpages or web services, it should also include the appropriate communications technology for this. Note that devices of the same architecture as device 1 may also be used to provide claimed location information for comparison. There may be circumstances in some embodiments where a relying party is an owner of a type of device 1 (who may be an individual) and wishes to authenticate another individual having a device 1 (see later on in description).

Other apparatus 60 associated with relying parties are also shown in FIG. 5. Three devices are shown in total for illustrative purposes only. It will be appreciated that there may be one, a plurality or many involved in the system.

The database 52 of the comparing apparatus 2 stores a plurality of identities (termed “TouchPass” IDs). These are obtained when a party registers with the system. They essentially identify the party to the apparatus 2 so that a location comparison can be carried out with respect to the correct party. The TouchPass ID will be associated in the database 52 with a device 1 ID so that the system 2 can communicate with the device 1, and also communicate with the apparatus 60 (when associated with an apparatus 60 ID in the database 52).

A system of the general architecture described in relation to FIG. 5 may be used in embodiments of the present invention for a number of different types of transactions.

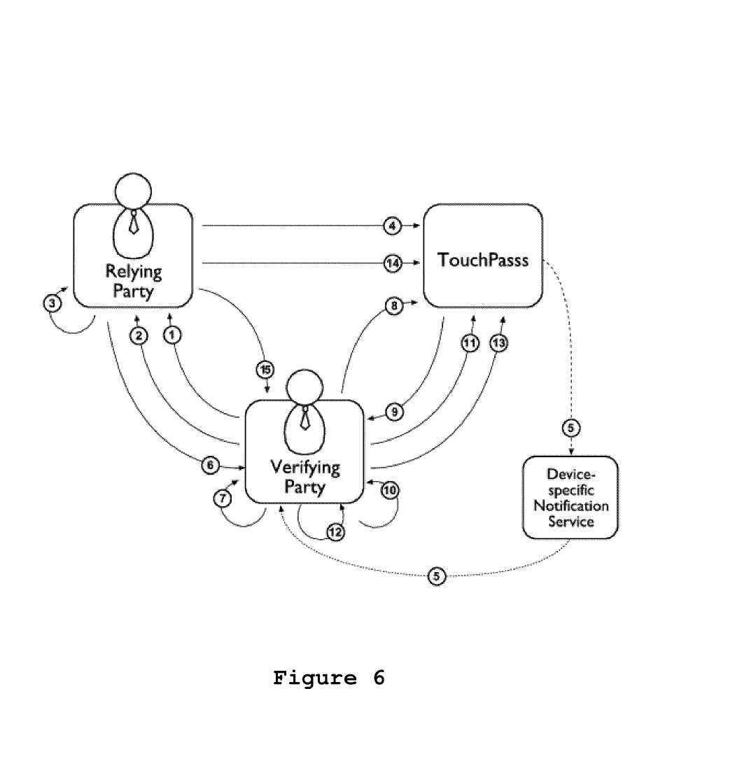

A transaction process utilising the system of FIG. 5 for authenticating a verifying party to a relying party, via the TouchPass (TP) comparing apparatus, will now be described with reference to FIG. 6, in general terms.

TouchPass (TP) is arranged to perform geodetic authentications for relying parties, such as merchant websites, financial institution websites, or other. Consider a relying party (RP) that wishes to make a privacy-respecting determination about the location of a verifying party (VP), equipped with a location-aware device 1 and the TouchPass application (location verification application 10). FIG. 6 illustrates the steps in an example PRP location verification protocol, particularly for relying party system 60 which provides a web interface, such as web shopping, web banking, or access to a secured resource over the web, or other web service.
1. VP visits web site 62 and requests access to a secured resource, or requests an action that requires authentication.
2. VP provides claimed location information to RP as part of the transaction. For example, VP enters delivery or billing address for an e-commerce transaction into the RP's web application, or the RP obtains known physical address from credit card billing information provided by the VP. This occurs outside the RP-TP-VP service interaction.
3. RP creates PRP-hash of claimed location. PRP-hash contains a bounding box specified at one of four possible resolutions (selected by the RP). Resolution options include: street, local, metro, and regional. The PRP hash is created by the location information providing application plug in 62 on the RP's system 60.
4. RP creates a location verification transaction and posts it to TP via the TouchPass API. The TouchPass API is an application enabling the system 60 to interface with the authentication system 2 via the communications network 65.
5. If VP has configured their account for notifications, TP initiates a notification to the device registered to the VP. Notification from device-specific notification service (e.g. Apple™ iOS™ Notifications) travels out-of-band to device and is not part of the TP protocol.
6. RP informs VP to start the TouchPass device application on their device, or VP notices incoming notification and clicks alert to launch TouchPass device client application.
7. VP device app starts up and initiates a location query from the operating system.
8. Device app connects to TP service.
9. Device app pulls down any new location verification requests.
10. Device app requests approval from user to acknowledge or reject the location verification. For each active location verification request, the device app requests approval from user to acknowledge or reject the location verification
11. If rejected, the VP device app posts an update to the location verification that rejects it. When the RP next polls TP, they will notice that the user rejected the location verification, and then take RP-specific action.
12. If acknowledged, the device app uses the bounding box resolution specified in the request to create a PRP-hash based on the current physical location of the device.
13. The VP's device app updates the location verification request with verified PRP-hash information using the TouchPass API.
14. RP polls TouchPass until location verification status changes state from ACKNOWLEDGED to either VERIFIED or UNVERIFIED, or until the RP decides to time out after a period of their choosing.
15. RP provides feedback to VP on success or failure of location verification.

At the end of this interaction, the relying party has information that confirms the location of the verifying party relative to their claimed position. The TouchPass service has no record of the actual physical locations, apart from a record that confirms that the verifying party was proximate to the claimed location.

Once a proximity determination is made, the service can then go on to either allow or disallow operations.

The above described protocol may be used in a number of different transaction applications.

Web shopping is one example. In this example, the RP may be an on-line merchant serving web pages 62 to the communications network 65 for shopping via connected computers. For example, the VP may be shopping via the web. The RP requires authentication based on location. In some circumstances this may be in addition to receiving the credit card details of the VP. The location authentication serves a second factor authentication.

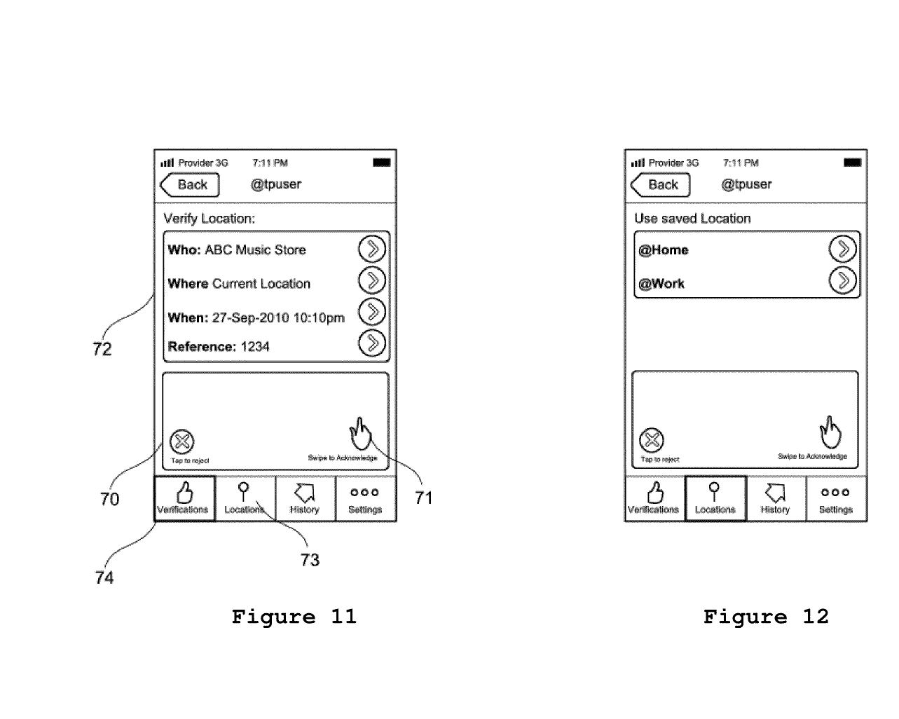

FIGS. 11 through 14 illustrate displays for a touch screen type mobile device 1. These example displays may be generated in response to the verifying process illustrated and described with respect to FIG. 6, for an on-line shopping application. In this illustrative example, the VP is purchasing music from an on-line store and the RP (the merchant selling the music) requires location authentication.

At step 9 of the illustrated FIG. 6 process, the device application obtains any location verification requests. In the embodiment illustrated in FIGS. 11 to 14, the user swipes their finger across the bottom panel to acknowledge the verification (ABC music store requesting current location). Tapping the “x” 70 rejects the verification request. Swiping the “finger” 71 acknowledges the verification requests.

The “where” option 72 allows the VP to use a previously stored location (from “locations” 73) instead of their current location. The user can then pick from one of the locations saved in the user's location list (see later).

Clicking the right disclosure button in a verification allows VPs to make use of a previously saved location (FIG. 12). As discussed above, the location will be obtained and hashed and sent to the TouchPass system. Note that if it is a stored location, it may already be stored in hashed form.

Note that a tap of the verification button 74 can always return the user screen to the verifications requested.

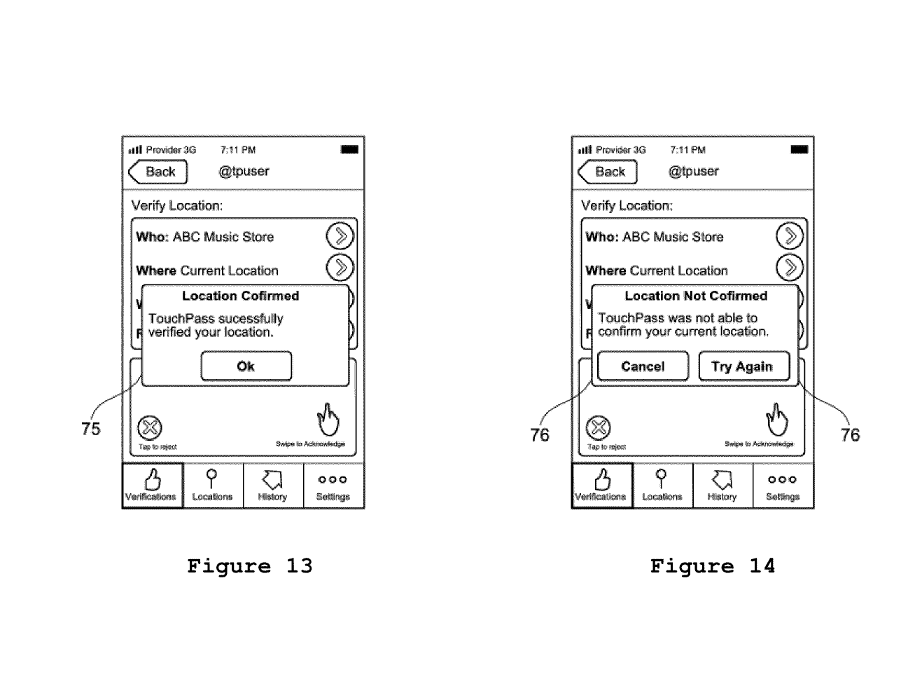

FIG. 13 indicates a message at 75 that the location has been confirmed and that the TouchPass system successfully verified the location with the RP. FIGS. 14 and 76 illustrates the display when the location was not verified. Note that there is a Try Again button 77 to enable location matching again.

The displays of FIGS. 11 to 14 are one example set of displays only. The information could be displayed in other ways and the invention is not limited to these representations.

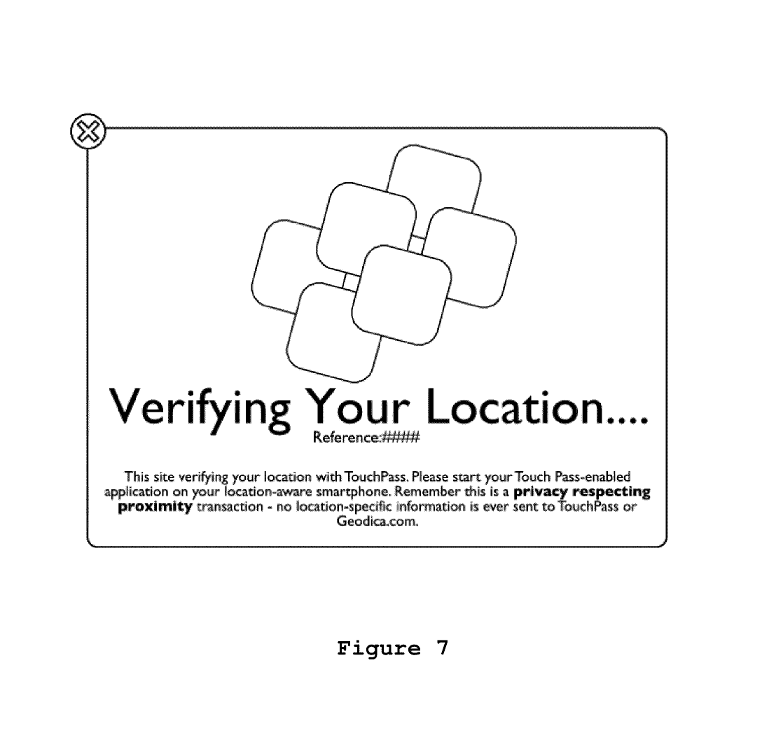

Any type of web shopping may be implemented in accordance with the process described with reference to FIG. 6 and FIGS. 11 to 14. FIG. 7 illustrates a display which may be served by system 60 when verifying location for a transaction. A screen may appear when the web merchant wishes to verify your location. But note that this is one example screen only, and other displays may be used.

Another scenario where geodetic authentication is useful would be in an online banking scenario where an institution wishes to ensure that a user is operating from a location known to the bank and authorised by the customer, such as home or work. In this example, both the bank and customer are well aware of the specific location, but it is not relevant for the service offering the authorisation (TP). The bank (in this case system 60) uses the PRP algorithm encoded in software running at the bank's site (with secure access to bank data) to calculate the bounding box coordinates for the known location. These coordinates are sent to the TP 2, which attempts to match the coordinates with equally encoded values sent from the user's device 1. If the hash values match, then the service can confirm that the user is in the specified location without any knowledge of the specific location leaking to a third party.

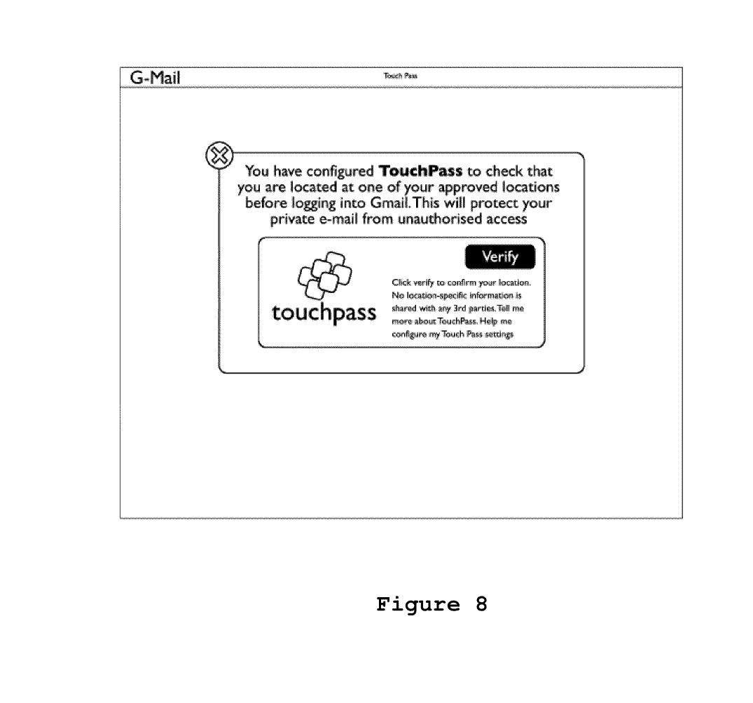

Another application where the geodetic information is useful is for access to secure services. For example, the authentication process could be used to access webmail e.g. Gmail™. A user of the webmail may only wish to authorise use of webmail when they are at specific previously registered locations (i.e., locations registered with the webmail provider, being the RP in this situation). The process is then similar to that detailed in FIG. 6. FIG. 8 illustrates the type of display that may be provided by the webmail service to instruct the user to implement the TouchPass system. Once the location of the user is authorised, access to their webmail will be allowed.

Another novel use of geodetic authentication is in card-not-present transactions.

Card-not-present transactions occur when a merchant takes a customer's credit card details over the telephone or online. In this situation, the merchant does not have physical access to the card and so this removes one of the most important security mechanisms from the transaction: the card itself. It is possible to use a geodetic transaction to improve the security of card-not-present transactions, by binding environmental information such as location and time into a signed message from the user.

If a merchant is shipping goods to a customer, then it is possible to execute a geodetic authentication that confirms that the customer is located at or near the location of either the billing or shipping address. Confirming that the customer is located in the precise physical address of the cardholder or recipient significantly raises the confidence that the transaction is valid. This kind of transaction almost completely nullifies the use from a foreign country of a stolen credit card.

Another novel use of the geodetic authentication mechanism is in the prevention of fraud at POS and ATM using fraudulently obtained card data (also known as “carding”). In the typical carding scenario, attackers obtain card data from a compromised e-commerce site or by using a skimming device attached to an ATM or point of sale (POS) terminal. Once obtained, criminals manufacture new clone cards from the skimmed card data. Criminals then use the cloned cards at point of sale to acquire goods for resale, or at ATMs to withdraw cash.

With a geodetic authentication mechanism, the issuing institution for the card can verify that the actual card owner is physically located near the POS terminal or ATM used for a transaction. If the real cardholder cannot be location verified, then the issuer can choose to cancel the transaction, or block the card for any further activity. This process works because the issuing or acquiring institution already knows the location of the terminal, and can encode that into a location verification request which can be completed by the authorised user standing in proximity to the POS terminal or ATM.

Geodetic authentication opens up some interesting possibilities beyond the traditional online uses of second factor authentication. For example, it can also work as a physical security mechanism to provide access to secured areas. In this scenario, a person would use a traditional electronic pass on a locked door. The security system triggers an authentication request to the authentication service. The person then launches the authentication application on their device, which registers its current location. The user is prompted by the application to authenticate, which sends a message back to the service. If successful, the service returns a confirmation to the security system and the door is unlocked.

This mechanism introduces an out-of-band, second factor mechanism into a physical security scenario. It also means that stolen electronic door keys are essentially useless unless the criminal can also steal the accompanying mobile device that has the appropriate client application running on it.

As discussed briefly above, it is possible for a user to “save” locations for future use in authentication.

The idea behind saved locations is to allow a TouchPass user to store several saved locations in the device application under user-selected names, and then be able to use one of those locations in response to a future verification request.

Saved locations exist so that it is possible for a user to remember locations in the device that they might need to use more often, and in particular, when they might not actually be at the location right now. This is useful, for example, in e-commerce scenarios where the relying party wishes to verify a home (or billing) address for a credit card. The TouchPass user can effectively check-in to a home or business location at a time of their choosing, and then use those coordinates in a location verification request from a relying party at a later point.

There are two places where saved locations are used in the application:

### 1. During a Location Verification Request:

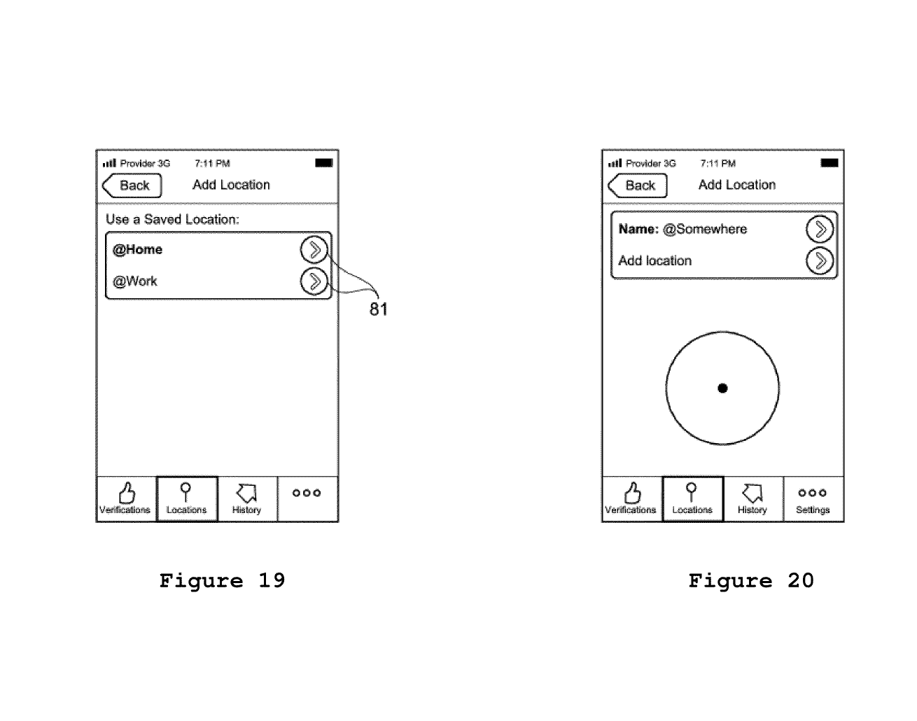

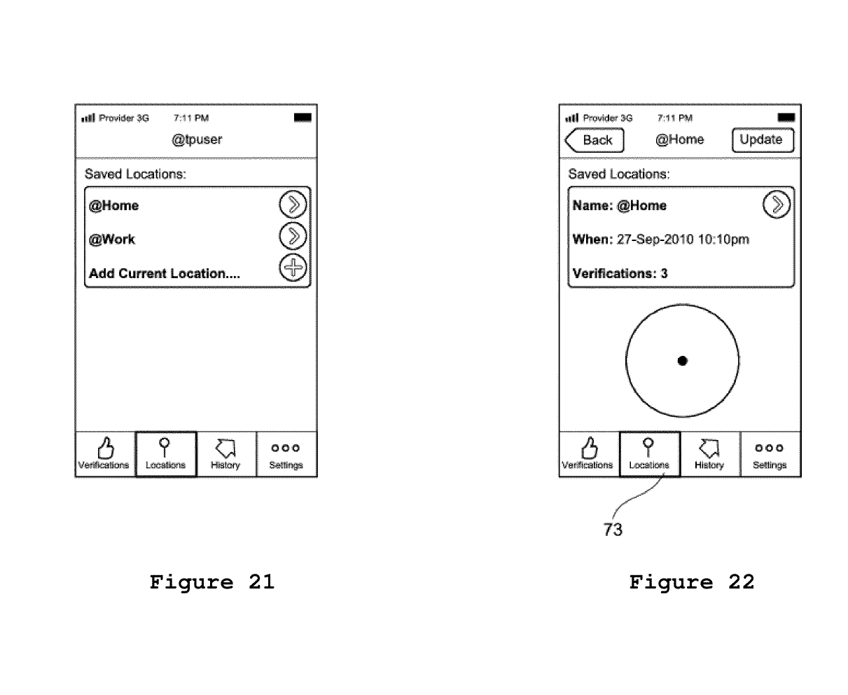

1. In the normal location verification use case, the user is presented with the “Verify Location” panel with the “where” field set to “Current Location”. This means that the app acquires the device's current location coordinates. However, if the user presses the right disclosure button on the “where” field, then the user is presented with their list of saved locations (see FIG. 19, showing “Home” and “Work” locations saved).
2. Selecting one of the saved locations from this list will use the saved location coordinates in the verification rather than the device's current coordinates.
3. Clicking the disclosure arrow 81 on a previously saved location takes the user to a page that shows the user the location on a map, with the ability to change the saved location's name.
4. Note: text should be “add” when adding a new saved location (see step 7 below) and “save” location when updating an existing saved location (see FIG. 20).
5. The Locations tab bar menu at the bottom of the app allows the user to manage their saved locations.
6. When selected, the user sees their current list of saved locations, plus the option to add their current location to the list (FIG. 21).
7. Clicking “Add Current Location” jumps to [4] (above) which gives the user the ability to name and store the current location.
8. Note that standard iOS™ swipe-to-delete mechanics should work on the list of saved locations.
9. Clicking the disclosure button displays details of the saved location, giving the user the opportunity to update, which updates the “when” field to the current date/time and resets the verification count (See FIG. 22).

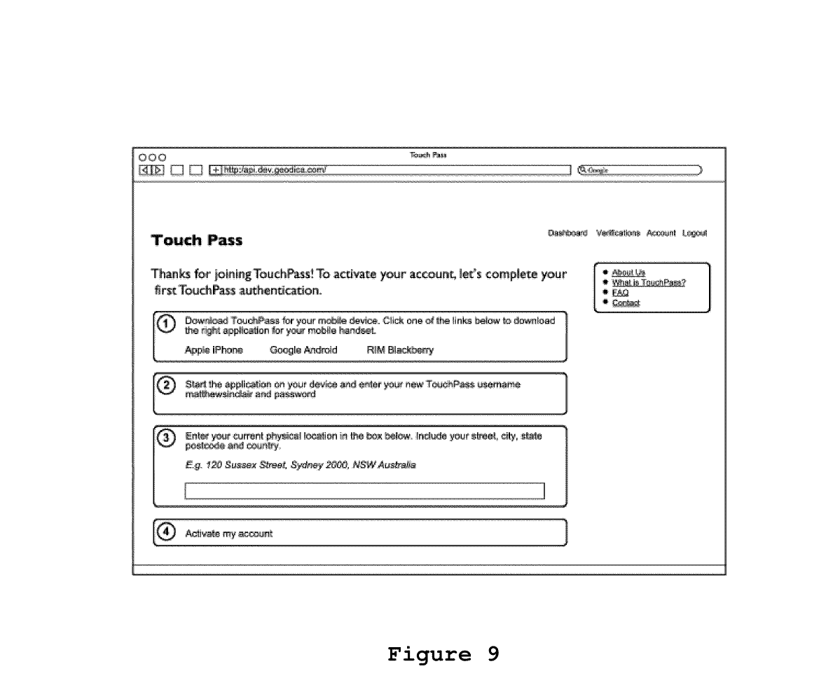

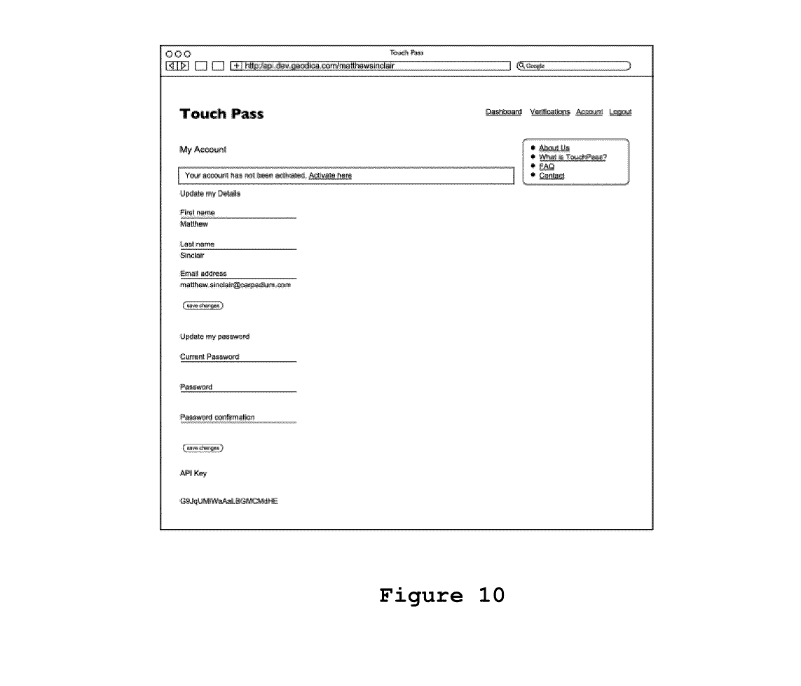

In order to utilise the geodetic authentication service in accordance with this embodiment, the VP and RP must undergo a registration process with the TouchPass apparatus 2. FIGS. 9 and 10 show an example registration page which may be accessed over the web. It will be appreciated that these are example pages only.

There are two types of registration in this embodiment:

1. TouchPass account registration.

2. TouchPass device activation.

Account registration for VP and RP is the same. This is in line with standard web account registration processes. The VP or RP logs onto the web service provided by the AP (TouchPass) and creates an account. To create the account, the AP service may request the usual personal details. The service then issues them with a user ID (in this embodiment termed “TouchPass” user ID) which they will use in transactions.

Device registration involves an initial location verification with the user's selected device. The user visits the AP web service and enters their current location (which is not retained by the service). The AP service then creates an initial location verification which is completed with the user's device as per the normal process discussed above. The difference in this particular case is that the TouchPass service plays the role of the relying party for this initial transaction. No physical location information is retained by the TouchPass service. An alternative mechanism for this process executes the same process, but the transaction is initiated from the user's device and not the TouchPass service.

The only information stored by the AP service is the user ID and a credential that allows the user to access the site and the service's API. For each device that the user registers for use with the service, TouchPass maintains a unique device ID, along with appropriate cryptographic material to support hashing, salting and encryption.

Registration allows the appropriate applications to be downloaded to the user device, e.g. the location verification application 10. Similarly, an RP may download the location information providing application 62.

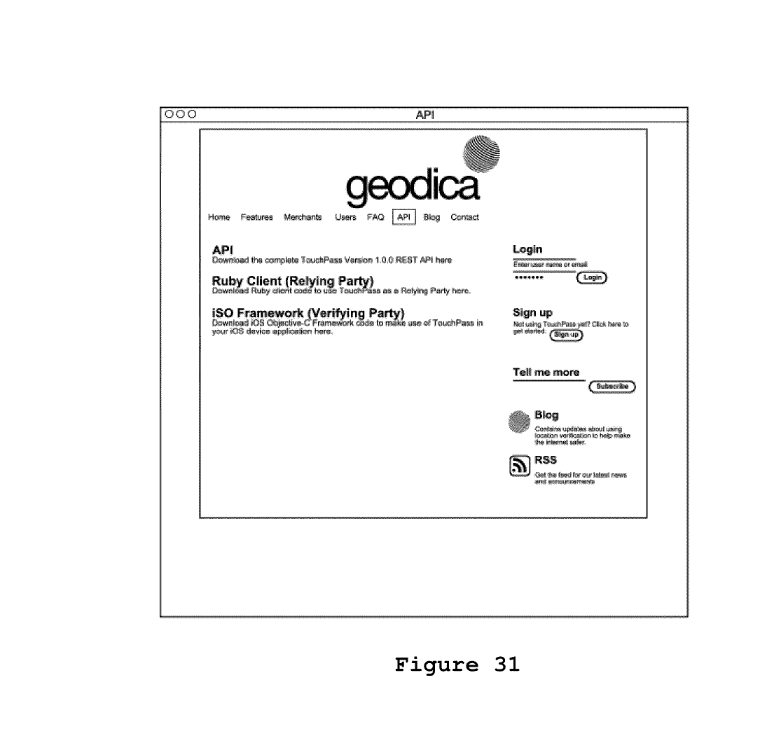

FIG. 31 shows a further screen which may be provided by the device 2 on registration. Note that the term Geodica™ is a trade name only, and this invention is not limited to that name. Nor is it limited to the particular presentation of the display, which may be varied.

From FIG. 31, the RP may download to their system 60 the location information providing application 62 “Ruby Client” in FIG. 31). As discussed above, the applications may be written in any programming language or implemented in firmware or by other mechanisms. The programming language is not limited to Ruby. The verifying party may download to their iOS™ framework (in this embodiment—could be any device 1) a location verification application 10. In this embodiment it is shown as being suitable for iOS™ Framework. It will be appreciated that it may be any software arranged to implement the application on any suitable device.

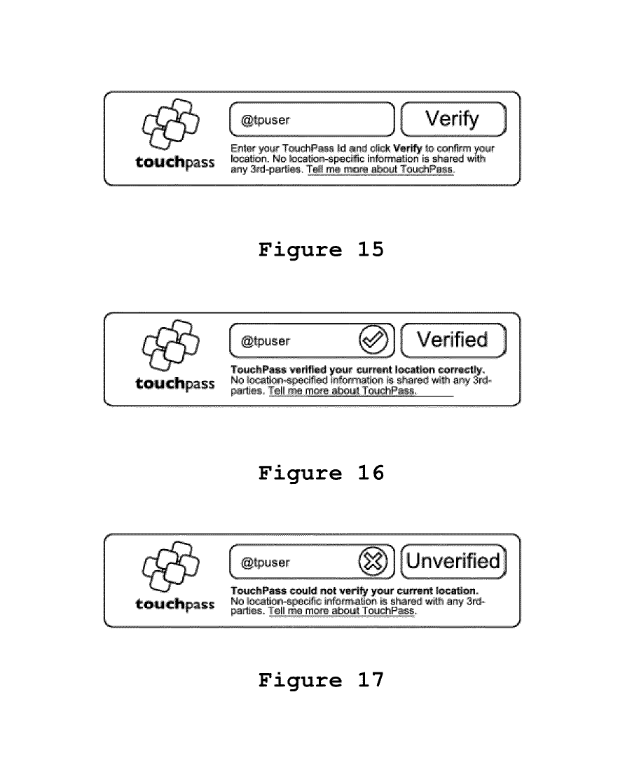

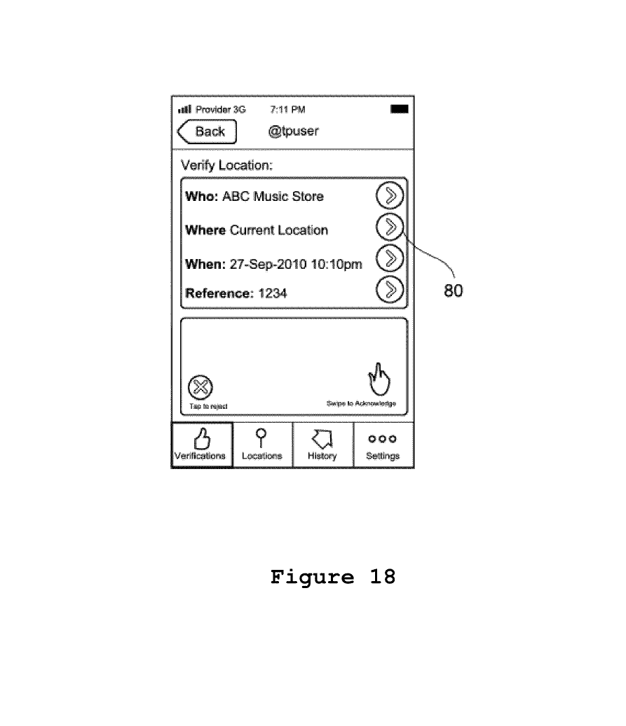

FIGS. 15, 16 and 17 illustrate screens which can be generated by the device 2 and over the web in order to allow the RP to trigger a location verification inside their web application to determine that they are registered and that the system is working properly. There are three states, pre-verification (FIG. 15), successful verification (FIG. 16) and unsuccessful verification (FIG. 17).

As discussed above, the geodetic authentication process and apparatus of this embodiment of the present invention can be used for a number of different applications. As well as person to organisation (e.g. financial institution, merchant, etc) authentication, a further application is person to person authentication. If applications allow a group of people to be authenticated as being near a particular place, or groups of people being near each other.

There are many circumstances where it is important for individuals and services to know who they are dealing with, but where the cost of using traditional authentication mechanisms makes their use uneconomic. Examples include establishing the veracity of a seller in an online auction, establishing the credibility of potential partners in an online dating service, or simply commenting on blogs or newsgroups. Whilst it is true that a top-down approach to identification and authentication would technically work to reduce fraud and improve security and privacy, the simple fact is that the costs of existing mechanisms are such that people are generally not prepared to pay per-transaction for them. Service providers are even less prepared to roll out the infrastructure required to support these extra measures because the risks are difficult to quantify and are often borne entirely by the customer.

In an embodiment of the present invention, these issues may be ameliorated using person to person authentication (P2PA), utilising the authentication process and apparatus of this embodiment.

A starting point for understanding P2PA is with an example of the problem it solves.

Consider an online auction site. One of the biggest problems with online auctions is the escrow fraud scenario where a seller fallaciously lists an item for auction, collects a payment from the winning bidder and then fails to send the goods. The current approach to this problem involves the introduction of a reputation measure that allows potential bidders to appraise the putative quality of the seller before bidding. The premise is that sellers with good reputations are unlikely to engage in fraud, and that educated bidders will be able to spot potentially fraudulent listings. Unfortunately, this mechanism is easy to game by fraudsters who sell a number of low value items to lift their reputation, before selling a single large value item that they take payment for, but do not deliver.

Similar problems plague sites which bring together buyers and sellers in a regionally categorised classified advertising site. Such sites have been very successful, contributing in no small measure to the 50% fall in year-on-year classified advertising revenue collected by mainstream newspapers. However, escrow fraud is a limiting factor that makes many potential users wary, costs some users real money through fraudulent listings, and ultimately traduces the reputation of such sites. These sites are more susceptible to the escrow fraud problem than on-line auction sites, because they replicate the traditional newspaper classified operating model, and as such, does not facilitate payment between buyers or sellers.

Because the incidence of online fraud is high, there are real risks to users. Although difficult to quantify directly, these risks essentially equate to the indirect cost of doing business online. From an economic perspective, users are willing to pay these indirect costs because the direct utility derived on average from an online service exceeds its indirect costs on average.

However, the real problem is that individuals do fall victim to online fraud and identity theft. When it does happen, all of that perceived utility evaporates pretty quickly. Authentication allows people to know whom they are dealing with when interacting online, but the costs of rolling out traditional, second factor authentication (2FA) systems across a large-scale Internet application are prohibitive.

The common theme in these examples is that they are all person-to-person communication systems: connecting sellers and bidders for online auctions; connecting buyers and sellers for online classifieds; social networking sites connect groups of friends; and dating services connect potential partners. In each case the network of connected users is large and vibrant. Unfortunately, the missing ingredient is a very-low-cost mechanism for people to reliably know whom they are dealing with.

The underlying notion behind person-to-person authentication (P2PA) is simple: provide a mechanism that allows people to identify themselves to each other in a way that provides some credible extra evidence over and above an unverified claim, that they are who they say they are. The challenge is to enable such a capability across almost any site on the Internet without the need to change those sites or the user's computing infrastructure to make it happen.

For example, an on-line auction seller, someone listing a classified ad, or a potential date could validate their account name and profile using a person-to-person authentication mechanism, display that claim in a listing, and then allow potential bidders to independently verify their authentication details without recourse to any infrastructure run by the service.

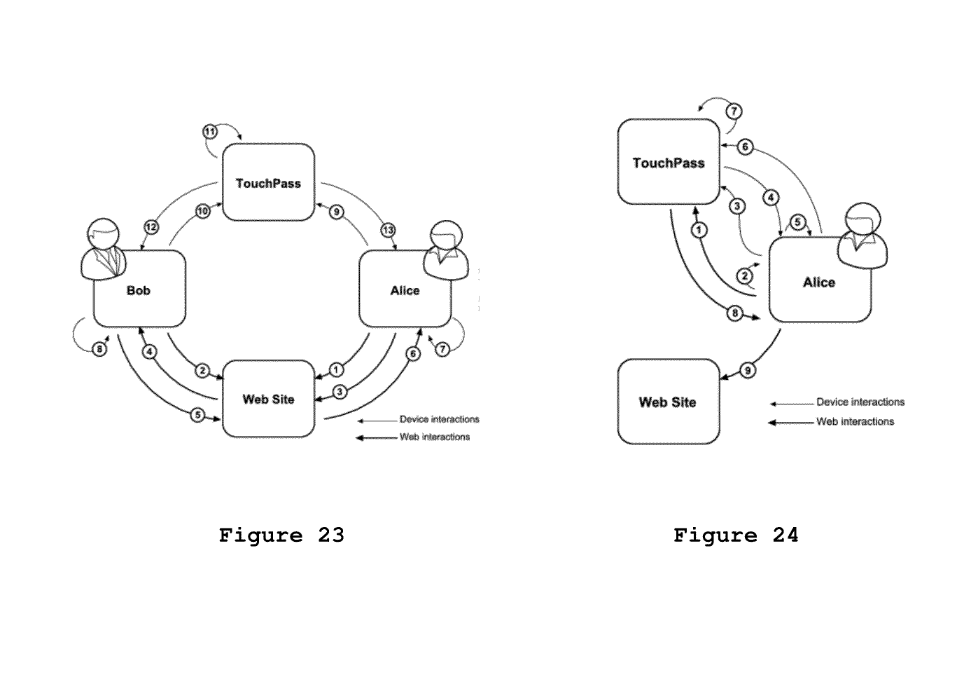

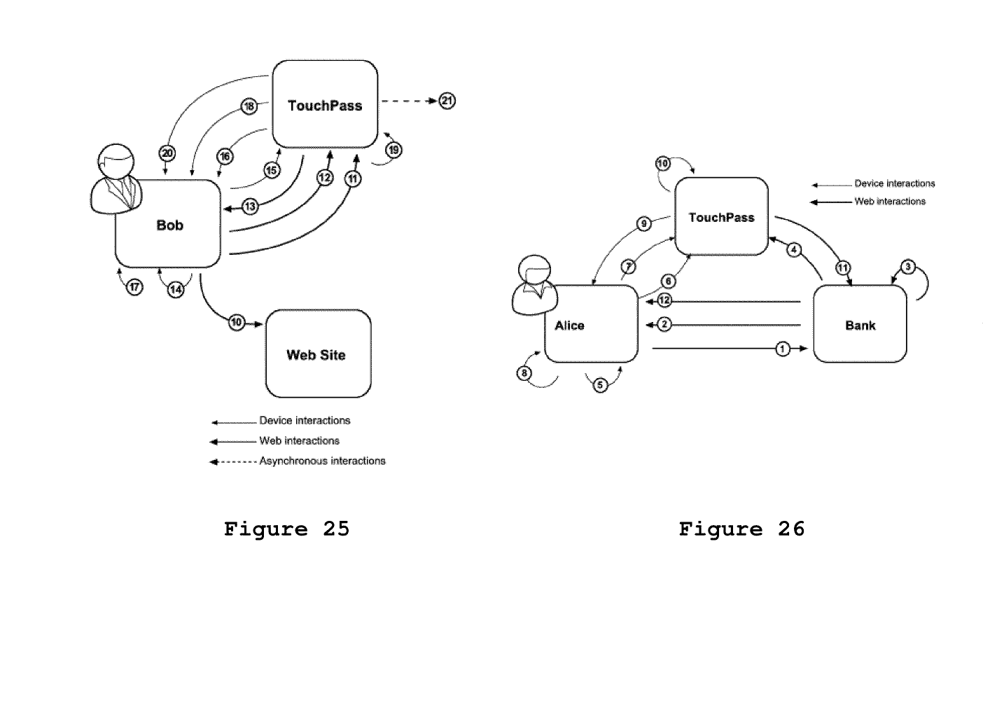

There are two different types of person-to-person authentication in accordance with embodiments of the present invention:
SYNC-MA: synchronous mutual authentication (see FIG. 23)
ASYNC-MA: asynchronous mutual authentication (see FIGS. 24 and 25)

A mutual authentication transaction allows two users to learn something about each other that gives them some level of confidence that they are dealing with a real person. It is possible to perform a mutual authentication operation synchronously, where both users perform the operation at the same time, or asynchronously, where users perform their respective halves of the operation at different times.

Synchronous mutual authentications are useful when both people are physically online at the same time, for example, when two users wish to establish a person-to-person “friend” or “follower” relationship in a social network site, or in an online chat room. Asynchronous mutual authentications are useful when the authenticating pair is not online at the same time, for example, when a user wants to validate that they are a legitimate seller in an on-line auction or classified ad, and the potential user on the bid or buy side of the transaction might be browsing the listing at some other time. The asynchronous approach also works in the social networking examples.

In each case, the authenticated information relates to a verified physical location of the device, and an independent claim made about that location by the user. These claims also make use of the PRP to ensure that there is no unnecessary leakage of personally identifying information.

### Synchronous Mutual Authentication (see FIG. 23)

Consider a generic web site at which users Bob and Alice are members. Bob and Alice do not know anything about each other, apart from the usernames allocated to them by the site. Consider the TouchPass service that facilitates the person-to-person authentications, and for the purposes of this example, assume that Bob and Alice both have location-aware mobile devices with the TouchPass client software installed. FIG. 23 presents the interactions for an M-AUTH operation that allows Bob and Alice to learn something about each other that provides some evidence that each is who they purport to be.

The steps in an SYNC-MA operation are:
1. Alice visits the web site
2. Bob visits the web site. Bob and Alice meet online, and agree to mutually authenticate using the TouchPass service. They agree to share their postcodes and to confirm that they are currently situated in that location. Depending on the degree of authenticity required, Alice and Bob could agree to share as much or as little of their addresses as they felt appropriate. For the purposes of this example, a simple postcode is sufficient.
3. Alice reveals her TouchPass identity and postcode to Bob using a communications mechanism provided by the web site. This could also occur via e-mail or any other appropriate mechanism.
4. Bob receives Alice's TouchPass identity and postcode.
5. Bob reveals his TouchPass identity and postcode to Alice.
6. Alice receives Bob's TouchPass identity and postcode.
7. Alice starts the TouchPass application on her device. She initiates a SYNC-MA operation in the application and enters Bob's TouchPass identity. She selects the postcode exchange option and enters his postcode into the available field. The application queries the operating system of Alice's device and using the PRP algorithm, generates a hash of her current location.
8. Bob starts the TouchPass application on his device. He initiates an SYNC-MA operation in the application and enters Alice's TouchPass identity. He selects the postcode exchange option and enters his postcode into the available field. The application queries the operating system of Bob's device and using the PRP algorithm, generates a hash of his current location.
9. Alice's device creates a SYNC-MA message and sends it to the TouchPass service. The SYNC-MA message contains the PRP hashed coordinates of Alice's current location, along with an encrypted version of Bob's TouchPass identity and postcode.
10. Bob's device creates a SYNC-MA message and sends it to the TouchPass service. The SYNC-MA message contains the hashed coordinates of Bob's current location, along with an encrypted version of Alice's TouchPass identity and postcode.
11. The TouchPass service matches the incoming SYNC-MA transactions (from 9 and 10). The application determines if Alice's current location matches the postcode specified in Bob's SYNC-MA message, and if Bob's current location matches the postcode specified in Alice's SYNC-MA message. It does this by independently creating PRP hashes for each specified postcode and comparing the hash values with those specified in the SYNC-MA messages.
12. If Alice's postcode (sent via Bob) matches her current location (sent via Alice), then the TouchPass service sends Bob a confirmation message to his device that Alice is currently located within the postcode that Alice provided to Bob. If not, Bob gets a warning message to indicate that the postcodes did not match.
13. If Bob's postcode (sent via Alice) matches his current location (sent via Bob), then the TouchPass service sends Alice a confirmation message to her device that Bob is currently located within the postcode that Bob provided to Alice. If not, Alice gets a warning message to indicate that the postcodes did not match.

If there is a problem with either one of the location verification operations, then no information is provided to the other party to the transaction.

If we assume that Bob and Alice both trust the TouchPass service, then after this interaction, both Alice and Bob know certain things about each other that they would not otherwise have known (reliably). They can each assume that the other is currently located in the indicated postcode, and they can both assume that it is unlikely the other end of the transaction is not a real person.

It is possible to draw these conclusions for two reasons. Firstly, it is expensive for an attacker to acquire a suitable device, and it is technically difficult to compromise it to participate in this kind of transaction. Even if that was possible, it is relatively simple for the TouchPass service to detect a compromised device and eject it from the system. Secondly, because Bob remits Alice's postcode and Alice remits Bob's postcode to the TouchPass service, it is quite difficult to create a situation where one party thinks they are checking one value, when in fact they are validating against something different. In combination, these factors allow Bob and Alice to be reasonably confident that they are who they say they are.

The advantage of the SYNC-MA mechanism is that it allows two users to verify location information about each other in a privacy respecting way without any requirement for technical support from the system or service they are using to communicate.

In the online auction or classified ad examples, this means that if Bob was the winning bidder on an auction or interested purchaser for a classified ad, he could hold off on making a payment until they had completed the SYNC-MA operation out-of-band. In the RSVP example, users can connect first using the service, but hold off on revealing more personal information until they had both executed an out-of-band SYNC-MA transaction using TouchPass.

This feature makes the process appealing because the barriers to take-up are very, very low, there is a genuine motivation for both parties to participate, and the costs of participating are low.

### Asynchronous Mutual Authentication

The asynchronous version of the SYNC-MA operation is similar in inputs and outputs to the synchronous version, with the exception that it is not necessary for the users to perform the operation at the same time. The difference is that the TouchPass service will not release confirmation of the SYNC-MA operation to each participant until both parties have performed their side of the transaction.

In FIG. 23, the TouchPass service waits for both steps 9 and 10 to complete before performing the location verification and returning the results to Bob and Alice (steps 12 and 13). Because it is possible (or likely) in this scenario that the parties are not simultaneously running the TouchPass application on their device, the TouchPass service will send a reminder notification (egg via e-mail or a notification mechanism of their device) to let them know that the authentication is complete.

Asynchronous mutual authentication is similar to the scenario described in FIG. 23, however in this example, assume that Alice is a seller on an auction site and Bob is a potential bidder who knows nothing about Alice other than her publicly available information that forms part the listing. In this situation, Alice wants to make a public statement that potential bidders can rely on to improve their assessment of her reputation, but she does not wish to unnecessarily reveal personally identifying information.

Alice can pre-validate her part of the mutual authentication in advance, and then publish a link to it that can be included in her listings. When a person interested in one of Alice's listings clicks the P2PA link they are directed to a statement that confirms the authentication occurred, but that does not reveal any specific information about its details. If a user wishes to view details of the authentication, then they must authenticate themselves to the same level.

The effect is to break the synchronous mutual authentication into two steps (see FIGS. 24 and 25).

Firstly, Alice performs her half of the authentication and receives a link that she can use in her auction listing:
1. Alice visits the TouchPass web site and requests creation of an asynchronous mutual authentication token (AMAT). The TouchPass service instructs her to start the TouchPass application on her device.
2. Alice starts the TouchPass application on her device.
3. Alice's TouchPass application connects to the TouchPass service.
4. The TouchPass service, in response to Alice's request (1) determines that it is required to perform an ASYNC-MA operation and instructs the application to acquire instructions from Alice.
5. The TouchPass application asks Alice how much location and/or proximity information she wants to verify. This can be at any level of detail from country down to street address. In this case, Alice wants to have her current postcode validated. The application asks her to enter her current postcode. The application queries the operating system and determines its current location, and then generates a set of PRP hash values based on the current coordinates. Note that the granularity of the PRP hash generation function depends on the level of the location that needs verification. For example, at the level of postcode, a granularity of kilometres (or greater) might be required, whereas a specific street address would need much less.
6. The application creates an ASYNC-MA message and sends it to the TouchPass service. The message contains the PRP hash, along with Alice's declaration of her current postcode.
7. The TouchPass service performs a geocode query to determine the coordinates of the specified postcode. It then creates a PRP hash using a granularity to match the location resolution specified (postcode in this case) and compares the resulting values to see if the location of Alice's device and the specified postcode match.
8. The TouchPass service prepares an AMAT for Alice and presents it to her (via the Web).
9. Alice takes a reference to the AMAT and copies it into the text of her auction listing as a link. This link provides a reference to a publicly available page that describes the claims made by the token, but without revealing any personally identifying information about Alice or contained within the claims.
10. Bob inspects the auction listing and clicks the authentication link.
11. The TouchPass service displays Alice's authentication reference to Bob. The reference contains a unique reference identifier and information about the nature of the claims. It contains no information about the specific claims or personally identifying information about Alice. In this case, the reference describes a claim made about postcode-level verification. The reference also contains a link that allows Bob to complete his side of the authentication.
12. Bob selects the mutual authentication link.
13. The TouchPass service asks Bob for his TouchPass id and tells him to start the TouchPass application on his device. Note: if Bob is not currently a TouchPass user, he is directed to complete TouchPass signup and device application installation.
14. Bob starts the TouchPass application on his device. Bob selects the option to complete an ASYNC-MA and enters in the id of the AMAT (acquired in step 11).
15. Bob's TouchPass application connects to the TouchPass service and supplies it with the AMAT id.
16. The TouchPass service sends Bob's TouchPass application details of the requirements to complete the authentication. In this case, Bob's postcode is required.
17. Bob enters his current postcode and the application queries the operating system to get the coordinates of Bob's current location. The application creates a PRP hash of the coordinates and builds an ASYNC-MA completion message containing the hash values, Bob's claim about his current postcode, and the original reference from Alice's authentication.
18. The application sends details of Bob's authentication to the TouchPass service.
19. The TouchPass service matches Bob's incoming authentication request with Alice's original. The service generates geocoded coordinates based on Bob's claimed postcode and creates a PRP hash. The service compares the hash values for Bob's claimed postcode with those supplied by the TouchPass device application. If there is a proximity match, then the authentication is completed. If not, the authentication fails.
20. The TouchPass service notifies Bob's TouchPass device application of the success or failure of the authentication. If successful, the application display's Alice's verified postcode to Bob, otherwise, no information is revealed about Alice.
21. The TouchPass service notifies Alice asynchronously about the successful authentication. This might occur via e-mail, or as a notification in the TouchPass application on her device when it is next started up. If Bob's authentication fails, then no information about Bob is provided to Alice.

Following this transaction, Bob can draw conclusions about Alice similar to those in the previous SYNC-MA example. The other important features of this transaction are:
Alice has verified her location without revealing specific information about the address.
Alice does not need to know anything about Bob beforehand.
Bob and Alice can be reasonably confident they are both real people with a real device, and they are both located within the boundaries of location information specified in the AMAT.

In combination, these factors allow Bob to be reasonably confident that Alice is who she says she is, and be reasonably confident that Alice is a real person.

### Person-To-person Information Escrow

An extension of the P2PA mechanism may be used to implement a complimentary process that allows two individuals to exchange personally indentifying information with each other in a way that respects privacy, prevents leakage to any 3 parties, and works so that information is only exchanged if both parties have completed their obligations.

Consider the example of an item for sale in an online classified ad. For security and privacy reasons a potential buyer would not want to give up personal details before being sure who the seller was, and vice versa. P2P information escrow can assist this process by capturing personally indentifying information for both parties, validating the location-based claims to some agreed level, and then revealing the information to each party only after both parties had completed their obligations.

Using the TouchPass device application, each user selects the information that they wish to reveal. For the purposes of the above example, we assume that parties agree to reveal their physical street address. Using the P2PA process described in FIG. 23, Bob and Alice initiate a P2P information escrow exchange. The TouchPass device application already knows the claimed address of Bob and Alice, and can create a PRP hash of their current position based on information returned from the operating system.

On each device, a pair of PRP coordinates is created, one from the physical location of the device, and one from a geocode query request based on the user's claimed address. Each device remits a P2P information escrow request to the TouchPass service containing the respective PRP hashes. The service verifies that the coordinates generated from the device and those generated from the claims match. If they match in both cases, then service sends Bob's public key to Alice, and Alice's public key to Bob. Each device encrypts the text version of their address details using the public key, and then sends the encrypted data to the TouchPass service, which forwards it on the other party. At no stage does the central service end up with any unencrypted personally identifying information, which makes the process entirely privacy respecting.

If the PRP hashes do not match in either case, then no information is revealed to either party. In the case where the reveal part of the escrow process fails, one or both parties would be advised to perform extra checks before going ahead with any kind of financial transaction.

This process also has application in the online auction and online dating scenarios.

Another application of an embodiment of the present invention is geodetic enrolment.

One of the biggest challenges with any form of electronic identity system is the process whereby new identities are created and enrolled. This is generally referred to the as the original identification problem. The basic idea is that no matter how transactionally secure an identity system is, ultimately its security is only as good as the weakest element. If it is easy to forge the documents or artifacts used to provide evidence of original identification for enrolment, then it is just as simple to create fake identities within the system. Once created, these identities can participate in transactions just like any other legitimately created identity, with the end result that those relying on the system must assume that at least some of the identities are fraudulent.

In financial services, this problem means that institutions are forced to take steps to ensure the accuracy and quality of evidence of original identification (EOI) documents. For example, institutions must at the very least sight documentation, and in situations where the original document is easy to forge, must perform some kind of check to ensure that the document matches up with valid, up-to-date electronic information contained in the database of the issuing authority. These extra steps are costly and introduce latency into sign-up and provisioning processes that can slow down product enrolment at best, or at worst, result in customers deciding not to sign up at all.

In embodiments of the present invention, it becomes possible to create a special type of transaction that provides some relief to the traditional problems of enrolment and original identification. The special kind of transaction is known as geodetic enrolment.

Consider the example of a customer wishing to sign-up online for a financial services product. Due to the AML (anti-money laundering)/KYC (know your customer) obligations of the institution, it is important that they know as much information about the potential customer as they can before providing them with account access. The extra steps required to verify the customer's personal information introduce a time lag into the enrolment process. This can be particularly problematic in straight-through processing scenarios, or for low-margin products where it is important to onboard customers with as little interactions with face-to-face or phone-based customer service representatives as possible.

Geodetic enrolment is an approach that can generate confidence for a potential service provider about address details provided by a potential customer. This extra confidence can be used to fast track the enrolment process. If it is not possible to acquire this extra level of confidence from a potential customer, then this can be a signal to the service provider that a more rigorous evaluation is required.

In a typical enrolment scenario, the institution is entitled to know personally identifying information about the customer. Indeed, it is a requirement that the customer reveals this information as part of the sign-up process, and an obligation of the institution to collect it. However, there is an obvious incentive for fraudulent customers to provide false information about their address, and all sorts of privacy and security regulations apply to the institution meaning that it must treat the customer's personally identifying information with the utmost respect.

The question is how to capture and verify location information and then share it with the institution in a way that is credible and does not unnecessarily reveal any information to a 3^{rd}-party.

Referring to FIG. 26, consider that Alice wishes to sign up for a new bank account with a web-only Bank. FIG. 26 shows how Alice can provide information to the institution about her address that is reliable, independently endorsed, and based on real location data from the physical world:
1. Alice visits the Bank's web site and initiates the enrolment process for a new account. She enters all of the requested personally indentifying information required by the institution, including her current residential address.
2. The Bank informs Alice that they wish to verify this address information using the TouchPass service.
3. Using TouchPass software running at the Bank, the Bank's enrolment system creates a PRP hash of the address information supplied by Alice in her application form.
4. The Bank creates an IS-AT transaction message and includes the PRP hash values generated in step 3. The Bank sends the IS-AT transaction to the TouchPass service.
5. Meanwhile, Alice starts the TouchPass application on her device.
6. The device connects to the TouchPass service
7. The TouchPass service tells Alice's device application that there is a request to verify her current location.
8. The TouchPass application on Alice's device queries the operating system to determine its current location. The application creates a PRP hash of the current location.
9. The TouchPass application sends the PRP hash values to the TouchPass service.
10. The TouchPass service compares the respective PRP hash values to determine if there is a match. Because the values compared are hashes of the specific location, the TouchPass service has no specific knowledge of the real location of Alice. There is also no other personally identifying information available to the TouchPass service. The only information shared is Alice's TouchPass identity and the PRP hash values generated by Alice's device and by the Bank's system.
11. If the TouchPass service determines that the hash values match, then it confirms proximity to the specified location to the Bank's systems. If the hash values do not match, then TouchPass service reports the failure.
12. The Bank confirms the result of the location verification to Alice.

At the end of this interaction, the Bank has information that gives it confidence Alice is located at the address specified in her application. At no point in the process is any personally identifying information about Alice or her relationship with the bank revealed to the TouchPass service.

A novel extension of geodetic transactions and privacy respecting proximity is the ability to bind delivery of an electronic item to a physical location. This has a number of interesting applications, such as:
Binding the delivery of an electronic message to a known physical location
Verifying that a courier delivery has occurred at the correct destination
Ensuring that a person-to-person payment arrives at a specific location, such as an international address
Arbitrating the exchange of digital property such as electronic trading cards
Confirming the acceptance of a retail deal or offer by binding it to a physical address

The easiest way to understand geodetic delivery is with an example.

### Example

### International Funds Transfer

Geodetic delivery provides some interesting opportunities for international payments. As anyone who has ever tried to send money overseas will attest, international transfers are one of the most expensive and time consuming banking transactions available to the average person.

Consider Alice in Sydney, who wants to send $50 to her niece, Charlie, who lives in London. Because Alice knows the physical address of Charlie, she can create a special kind of transaction that must be accepted at a designated physical address. By integrating a transfer with a geodetic delivery component, Alice can be sure that the funds go the right person. Adding a geographically specific component to the transaction also provides another level of identification over and above simply knowing a name and bank account.

### Example

### Secure Delivery of E-Mail

With an appropriately configured e-mail client, it would be possible to encrypt a message and have it decrypted only if the reader could verify using a geodetic delivery transaction that they were located in a specific location.

Consider a TouchPass plug-in for a web-based e-mail program. Assume that both Alice (sender) and Bob (recipient) have the plug-in installed into their web-mail accounts, and that Bob has an appropriately configured TouchPass-enabled location-aware device.

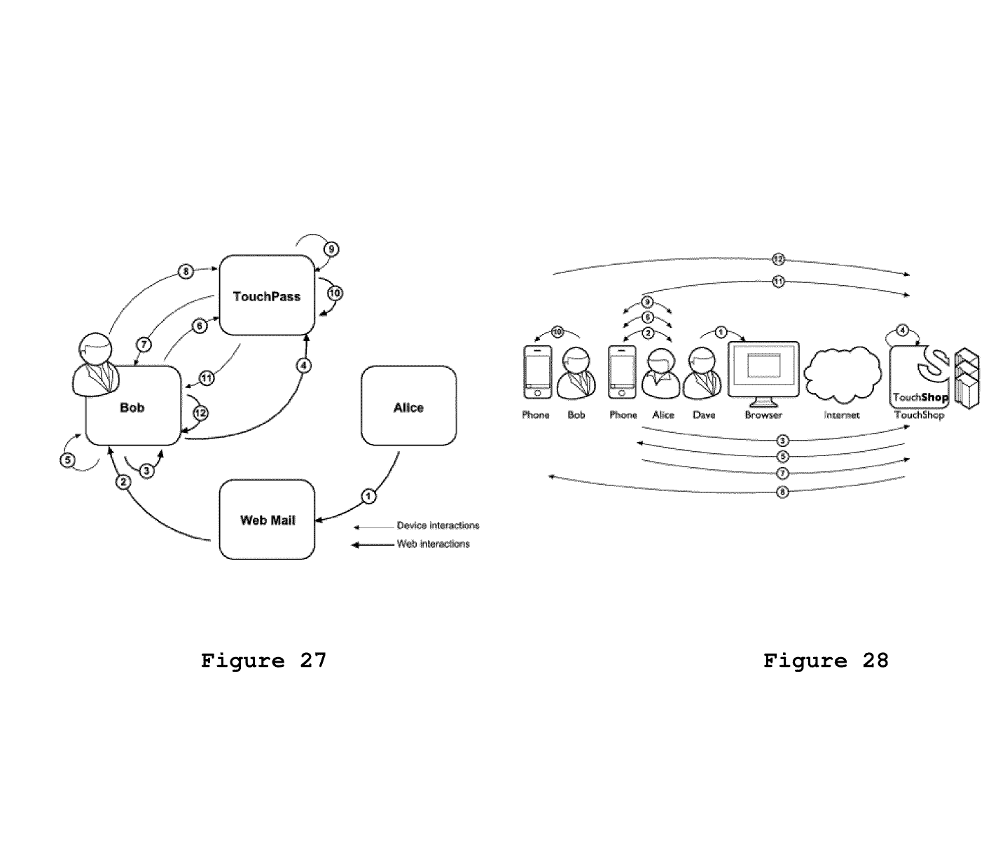

Using the plug-in, a geodetic delivery of e-mail would look like this (see FIG. 27):
1. Alice logs into her web mail account over the Internet and creates a new message that she wishes to send to Bob. She initiates the TouchPass plug-in and specifies that the message should be encrypted for delivery to Bob's physical address. The plug-in first encrypts the message using the public key of the intended recipient, ensuring that only Bob can see the cleartext version of the message. The plug-in then encrypts the message using the TouchPass public key, and sends the message using the normal send functionality of the web mail application. The message that leaves Alice's web mail is encrypted once using Bob's public key and once using the TouchPass public key.
2. At some time later, Bob logs into his web mail account and notices that he has a new geodetically delivered message from Alice.
3. Bob initiates the TouchPass plug-in and requests that the message be decrypted based on his current location.
4. The TouchPass plug-in in Bob's browser sends a request to the TouchPass service to initiate an IS-AT transaction for the location specified in the e-mail message (this includes the double-encrypted version of Alice's message).
5. Bob starts the TouchPass application on his mobile device.
6. Bob's TouchPass application connects to the TouchPass service.
7. The TouchPass service informs the application that is required to perform an IS-AT location.
8. The TouchPass application in Bob's device queries the operating system and determines its current location. The application generates a PRP hash based on the current location and sends the PRP hash values back to the TouchPass service.
9. The TouchPass service uses the physical address information (passed in at step 4) and creates a PRP hash using a geocode lookup. The TouchPass service compares the PRP hash values from Bob's device with the values calculated from the physical address in the e-mail address.
10. The TouchPass service checks to see if the PRP hash values match. If the values match, then the service uses its private key to decrypt the outer layer of the original message. What remains is Alice's message encrypted using Bob's public key.
11. The TouchPass service returns this text to the plug-in in Bob's browser with confirmation of the match in locations.
12. If the location check passes, then the plug-in decrypts the message using Bob's private key, resulting in Alice's original message in cleartext, which is displayed to Bob in his e-mail client.

This example makes some simplifications about the way messages are encrypted and decrypted and how the double-encrypted text of the message is passed between browser plug-ins running in the browsers of Alice and Bob, and the TouchPass service. Specific details about how and where a message is encrypted and decrypted are not necessary to describe the generic process of geodetic delivery. The key management and encryption/decryption strategies will vary depending on the technology used to implement the e-mail client plug-ins.

The main use for this capability would be in securing the delivery of sensitive documents so that could only be used in a location of the sender's choosing.

Geodetic delivery could also be used to confirm physical receipt of goods delivered by a courier. For example:
1. Alice prepares a parcel with a courier company specifying the parcel requires geodetic delivery confirmation.
2. Sometime later, Chris the courier arrives with the parcel at Bob's house and informs him that the sender required a geodetic delivery confirmation.
3. Chris starts the TouchPass application on his mobile device and initiates an IS-NEAR transaction, specifying Bob as the counterparty. The TouchPass application queries the operating system and acquires its current location coordinates. It prepares a PRP hash of the current location and sends the hash values to the TouchPass service.
4. Bob initiates the TouchPass application on his mobile device.
5. Bob's TouchPass connects to the TouchPass service, which lets the device know of an IS-NEAR request.
6. Bob's TouchPass application queries the operating system and acquires its current location coordinates. It prepares a PRP hash of the current location and sends the hash values to the TouchPass service.
7. The TouchPass service compares the respective PRP hashes from Chris and Bob's mobiles. If they match, then a confirmation message is sent to both devices.
8. Bob confirms receipt of the parcel.
9. Chris confirms delivery of the parcel.

This main use of this mechanism is to provide a real-time delivery confirmation to the sender, which would be useful in high-priority/same-day delivery services such as a bicycle couriers.

A further extension of geodetic delivery is when it is used to confirm acceptance of a commercial offer in a retail or shopping context. In this form, the invention allows for virtual retail coupons to be completed when a holder walks through a specific retail location.

The difference with geodetic completion over and above existing location-based shopping systems is that the geodetic completion approach is analogous to click-through banner advertising on the Web. First generation banner advertising systems charged advertisers based on the number of times their advertisements were displayed to end users. This is known as CPM (or cost per thousand) pricing. There are now systems that track click-throughs, and not just impressions. Click-throughs occur when a user actually clicks on an advertisement to visit the advertiser's site or offer. This approach is advantageous to advertisers because it completes the loop, allowing the marketer to be in direct contact with their (potential) customers. It also has significant advantages in terms of measurability, such that advertisers can get very precise information about the effectiveness of a particular advertising campaign.

Geodetic delivery introduces the notion of a walk-through, which lets the advertiser know when a customer walks through the specified physical location. In the same way that a click-through closes the advertising loop in an online advertising context, geodetic delivery allows a marketer to close the loop in a location-aware physical advertising context. For example, this would allow an advertiser to get metrics about the effectiveness of outdoor advertising, by tying in a billboard with a geodetic delivery transaction.

Like a click-through advertisement online, walk-through advertisements are free to establish for the advertiser, and invoke a cost only when the potential customer engages with the offer using their location-aware device.

This is how geodetic delivery for marketing and advertising works in general:
1. A merchant or advertiser uses an online service to create an offer that can be bound to a physical location.
2. Offers from multiple merchants are delivered to mobile devices via a number of mechanisms. For example, a user could browse a list of offers using their current location to sort the available offers. Another example could send a user an SMS or e-mail message when they moved into a particular area where an offer was available. Alternatively, a piece of outdoors advertising such as a billboard could contain information about the offer, encouraging individuals passing by to engage.
3. End user engages with offer, for example by visiting a specified web site.
4. Advertiser only pays following customer walk-through at specified physical location

There are a number of specific instances of this approach in marketing and sales. An example of its use for driving off-peak traffic follows.

### Generate Off-Peak Traffic at Dave's Cafe

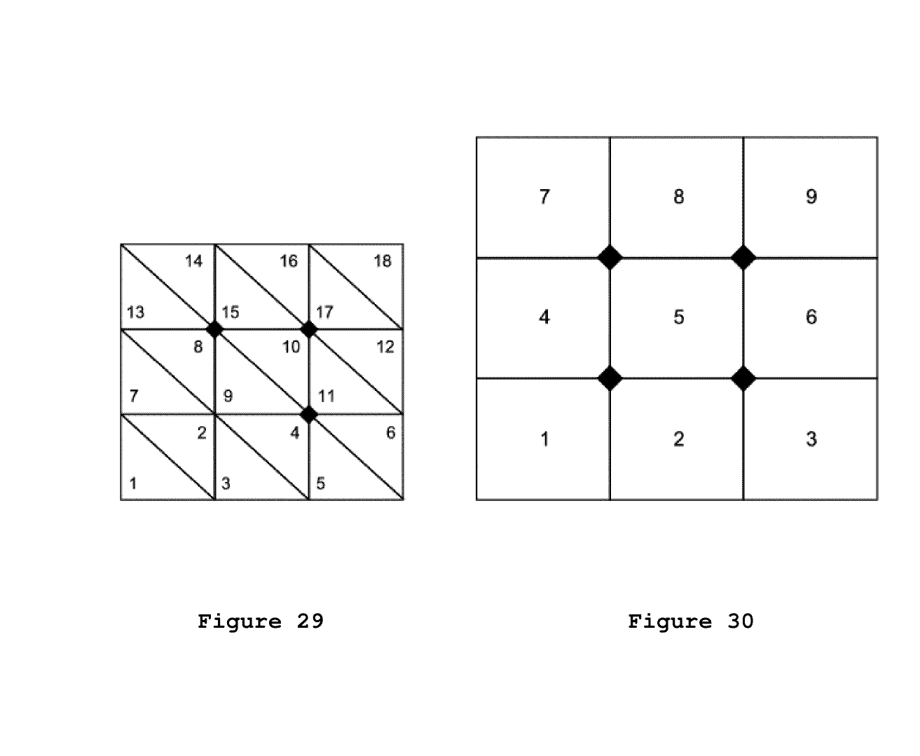

Consider the example of Dave (see FIG. 28), a coffee shop owner. Dave notices that traffic for takeaway coffees is extremely brisk from 7:30 am through until 9:30 am, after which business drops off precipitously until the lunchtime rush which starts to ramp up around 11:30 am. Dave is looking for a way to drive some extra business in the morning off-peak period. Dave uses TouchShop (similar service to TouchPass to establish a special offer to give away second cup of coffee for free, when 2 people come into the store between 9:30 am 11:30 am on weekdays.

Dave signs into the TouchShop web site and creates the offer (1). The offer includes a motivation and is time constrained in some way. In this case the motivation is the chance to get a second cup of coffee for free and the time constraint is that it is only available between 9:30 am and 11:30 am on weekdays. Importantly, Dave specifies the location at which the offer is valid, which in this case is the physical address of his café.

Bob and Alice are out shopping. It has just gone 10:30 am and Alice starts the TouchShop application on her device (2). The application contacts the TouchShop service and securely registers her current location (3). TouchShop checks to see if there are any offers in the area that Alice might be interested in (4). TouchShop recognises that Alice is in the vicinity of Dave's café and displays a message containing detail about Dave's deal (5). Alice uses the TouchShop application on her device to notify Bob (6, 7, 8), and then both Bob and Alice head to Dave's Café to take up the offer. On arrival, Alice lets Dave know that they are there to claim the 2-for-1 coffee deal. They both select Accept in the application on their phones (9, 10) to register their location at the store, and the devices notify TouchShop to complete the offer (11, 12). Dave gives them second cup of coffee for free. Fortunately for Dave, Alice and Bob sit down and also order a couple of orange juices and a couple of muffins.

TouchShop is completely free for Dave and Alice. Dave pays to use TouchShop either buy purchasing a bulk package of offers up-front and then using them as he deems appropriate, or alternatively, using TouchShop's unique walkthrough payment model. Walkthroughs are similar to click-throughs used for banner and text advertisements on the Internet. This approach gives Dave a zero risk option to use TouchShop where he only pays for the service when it generates real traffic into his cafe.

This can be used any time a retailer wants to drive traffic through a targeted, location-specific deal. TouchShop works very well for franchises or chain stores where offers can be created and managed centrally for a large number of locations.

Geodetic authentication in accordance with embodiments of the invention can be used as single factor authentication i.e. it can be used on its own as a method of authentication. It can be more powerful to use it as a second factor in an authentication process, however, which will add significantly to the security of the authentication process. Embodiments of the present invention therefore utilise geodetic authentication as a second factor in an authentication process, in addition to a party's other established identity (other factor in the authentication process).

As discussed above, it is considered that systems using single factor authentication, such as a simple username/password combination, provide weak authentication. Weak authentication systems are problematic for valuable transactions because they are susceptible to attacks by potentially fraudulent parties. In contrast, strong authentication systems use two or more of these mechanisms in combination, known as 2^{nd}-factor authentication (2FA). 2FA is stronger because passwords generated from a combination of multiple authentication mechanisms are much more difficult to guess, for both humans and machines, and hence tend to be more secure.

Whilst it is certainly possible to build a very secure authentication mechanism with combinations of these traditional factors, they are not without tradeoffs in terms of cost and complexity. Making something-the-user-knows (such as a password) more sophisticated so that it is harder for an attacker to guess also makes it harder for the user to remember. Integrating something-the-user-has (such as a hardware credential) into the authentication process tends to increase cost, either because it requires provisioning of a specialised security device such as a smart card or OTP token, or because of transaction costs incurred sending out-of-band (OOB) messages such as SMS.

The consequence of this cost/complexity trade-off is either reduced security or increased cost. When the user base or transaction volume is large, the costs of some security mechanisms can become prohibitive.

The use of geodetic authentication as a second factor (L2F) in accordance with embodiments of the present invention may have a number of benefits:
It is easier to use
It as safe as (or safer) than traditional 2FA
It can operate in scenarios where 2FA was previously thought too expensive
It can augment existing authentication mechanisms to improve security and reduce costs

L2F is easier because it can be used without needing passwords, keys or codes. This is possible because the device can accurately report its location (by virtue of GPS, cell tower triangulation, or WiFi access point location) to a remote server. This is extremely useful for online banking scenarios where a user can pre-register locations (egg home or work) from which they are likely to want to make high-risk transactions. The system can then check to see if the device is at one of the known locations before allowing transactions to proceed.

This kind of location-aware scenario is also potentially simpler from the user's perspective because an authentication involves little more than invocation of the application on the device to call back to the authentication service and register its current location. This approach obviates the needs for passwords, keys and codes in most cases, however it is still possible to have this extra level of authentication if the situation demands.

L2F is at least as secure as sending a one-time-password over SMS, and arguably more secure because it is not necessary to relay the authentication message over the communication channel, as is the case with SMS. Additionally, with the use of appropriate cryptographic operations on the device, L2F exceeds the capabilities of simple 2FA mechanisms by allowing for digital signing and other transactions requiring non-repudiation. Signing and non-repudiation are weak at best with SMS/OTP mechanisms.

In terms of price, L2A provides a compelling alternative to dedicated hardware and message-based authentication systems because it relies on a physical device that is already in the hands of the user, and it uses a communications mechanism that incurs no or little per-transaction costs for authenticator or user. This creates an authentication platform that is effectively free to use for end-users, with very low (or even zero) fixed costs to authenticators.

Hardware security mechanisms require provisioning of expensive smartcards and even more expensive key management infrastructure. OTP mechanisms require the provisioning of dedicated tokens, or involve per-transaction costs to send SMS messages over the phone network. In each case, the costs associated with a 2FA rollout are significant.

For example, the most common use of 2^{nd}-factor authentication in Australia is with online banking. Banks will almost always lock-down high-risk transactions, such as pay-anyone or change-of-address, with some form of 2FA. This creates real costs to the institution either because of the cost of provisioning specialised authentication hardware, or because of the transaction costs involved with sending messages out-of-band to the user. Banks will wear these costs because the financial risk of exposing customer accounts to phishing and other fraudulent behaviour are high enough to justify the expense.

Unfortunately (from a security perspective), 2FA is generally considered too expensive to use in non-financial contexts. This means that there are a variety of scenarios where 2FA could provide real user benefit, but where it is not used due to cost.

By using an appropriately configured geodetic transaction, it is possible to provide an authentication capability that has the potential to significantly reduce cost, be used in non-traditional 2FA scenarios, while at the same time improving the end user's security and online experiences.

In embodiments of the invention, location can be used as a second factor authentication with or without the anonymising process being applied to the actual physical location data. In one embodiment, however, it is utilised with the anonymising process being applied, in order to retain privacy.

In the above embodiment, a square or rectangular grid is used in order to transform the actual physical location data. The present invention is not limited to use of a square or rectangular grid, however. It is possible to create a grid in any other shape. For example, a triangular or other shape grid may be used. With triangles, for example (see FIG. 29) the granularity is halved and any proximate triangles will have 1, 2 or 3 coincident points.

In the example of FIG. 29, cells 4, 5, 6, 8, 9, 11, 12, 13, 14, 15, 16, and 17 share at least one common point with coordinates in cell 10. This equates to 6 units of area, whereas the square grid example (FIG. 2) equates to 9 units of area. Computationally, the square grid case requires comparison of two sets of 4 points (8 comparisons) whereas the triangle grid only requires comparison of two sets of 3 points (6 comparisons). For comparing two coordinates this is a trivial saving, but when the numbers of comparisons becomes large, a saving of 25% will have a measurable impact on overall processing load.

Other shapes than triangle or square could be used with other advantages.

The coordinates representing the location of a device are converted using software on the device or at the remote location into four different values using a one-way hash function. The one-way hash is a cryptographic function that applies a transformation to a string in such a way that the output is uniquely derived from the input, but has the property that it is very computationally difficult to derive the input from the output. This is also known as a one-way function. One-way hash functions are a well-understood and mathematically rigorous component of cryptographic technology.

The hashed coordinate values are privacy respecting because it is statistically highly improbable that an unauthorised 3^{rd}-party can derive the original location information from the hashed version of the coordinates. The hash function may be implemented in any known way.

Without the PRP algorithm, there is a risk that location information can be used in a way not authorised by the participating parties, or worse, subject to attack and misuse by unauthorised parties.

The uniqueness of the hash values is directly proportional to the resolution of the bounding box. If we set the granularity of the bounding box as 1 square metre, and assume the surface area of the Earth is approximately 5.1×10¹⁴ m², there are approximately 5.1×10¹⁴ cells into which an individual coordinate will resolve.

Obtaining accuracy of 1 square metre is beyond the capability of location-aware hardware in the current generation of devices, which means that the total available number of anonymised coordinates is significantly less than 5.1×10¹⁴. Assuming a reliable accuracy of 100 metres (1 hectare) reduces the available search space by 4 orders of magnitude, down to approximately 5.10×10¹⁰ possible uniquely addressable cells:

$$\frac{5.1 \times {10}^{14} {m}^{2}}{1 hectare} = 5.1 \times {10}^{10} Uniquely addressable cells$$

For a pair of arbitrary points to be considered proximate, then at least 1 of the hashed values for the four coordinates of each bounding box must coincide (see FIG. 30).

This means that for any single point, there are 9 possible nearby points. For example, in FIG. 30, if a second point resolves to be within points 1, 3, 7, and 9, then it will have 1 corner in common, or if it resolves to points 2, 4, 6 and 8 it will have 2 corners in common. If it falls within point 5, then all four corners will be the same.

The implication of this limit to the accuracy of the GPS coordinate extraction is that if an attacker can acquire the four hashed coordinate values, then they can execute a brute force attack and compare the values with a pre-generated list of possible coordinates. Even though the hash function makes it computationally difficult to recreate the original coordinates from the hashed values, there is no need to do this if the values can be compared to a finite set of known values in a brute force attack.

Even with this style of attack, it is still computationally challenging to brute force the precise location coordinates. Even at a rate of 150,000 comparisons per second, it would still require something in the order of 4 days to discover the matching coordinates. This could be significantly quicker on average assuming that other knowledge about the data (such as country of origin) could be used to reduce the search space.

$$\frac{5.1 \times {10}^{10}}{( ( 150000 \times 60 ) 60 ) 24} = 3.93519 days$$

To combat the finite search space of potential PRP hash values, it is possible, embodiments of the present invention, to add extra information shared between the coordinates before calculating the hash. For example, the TouchPass device application could calculate the “number of whole hours since a known date/time”. This mechanism only works if the other parties generating PRP hashes know the extra information so that they introduce precisely the same value, and therefore generate precisely the same PRP hash. This means that they should use the same starting date/time and that they are each time synchronised. For example, 12:05 and 12:55 would generate the same time offset value.

However, the time stamping approach is problematic for events occurring on the hour boundary. It could be possible that one device is set to 11:59 and the other device set to 12:01, which would produce a different time offset value, and therefore a very different hash value. This means that the all parties to the PRP hash have to be carefully synchronised, which is not feasible without resorting to sophisticated extra steps. Changing the time granularity from hours to days does not materially improve the problem (even if it does reduce the frequency) because there is always a boundary, and hence always the possibility that the parties will be on either side of the boundary.

The best way to achieve robust, per-transaction security of the information exchanged between RP, VP, in an embodiment, and TP service is to use a per-transaction, relying-party-specific salt. This requires the TouchPass service to provide each TouchPass device application with a large, random salt string in advance of the location verification transaction. Each device application uses this extra information to affect the results of the hash. Because all parties to a particular transaction use the same salt data, it will have precisely the same effect on the resulting hash values, but with the property that devices in proximity will still diffuse their specific location coordinates to the same hash values. Importantly, all parties to a transaction must use the same salt, which means that they must synchronise with the service to acquire the salt string before calculating the hash.

Adding additional information to each coordinate before creating the hash has the effect of increasing the search space for a brute force attack. Without such a mechanism, there are a finite number of cells (˜5.1×10¹⁰ with 1ha squares), which gives an attacker the opportunity to recreate the all of the possible hash values and compare them acquired against values. Therefore, the effectiveness of this strategy depends on all parties to the same transaction using the same salt value.

Securely exchanging the per-transaction salt uses the following protocol:
1. Assume that each verifying party (VP) has a public/private key pair.
2. Assume that the TP service has a copy of the public key for each device registered for use in the scheme.
3. When requesting a location verification transaction with the TP service, the RP acquires the public key of the VP.
4. RP creates a per-transaction salt value and encrypts it using VP's public key.
5. RP creates bounding box based on claimed location of VP and hashes using generated salt.
6. RP posts location verification request with encrypted, salted hash to TP service.
7. VP acquires salt value encrypted using their public key and decrypts. Because the salt was encrypted using the VP's public key, only the holder of the VP's private key (i.e. the VP) is able to decrypt it.
8. VP determines bounding box coordinates from device and hashes using salt per-transaction specific salt.
9. VP sends encrypted, salted hashed version of bounding box coordinates to TP service for comparison.
10. TP service compares claimed PRP coordinates from RP with verified PRP coordinates from VP to determine relative proximity.
11. TP reports results of proximity comparison to RP and VP.

Using this protocol results in PRP hash values that are very computationally difficult to brute force back into the underlying location coordinates, but leaves the PRP has values comparable in a way that allows RPs to know the proximity of a VP relative to a claimed location value.

In the above embodiments, the authenticating party (referred to as TouchPass in some embodiments) is an independent third party system. The invention is not limited to this. Authentication may be carried out by non-independent party, such as the relying party. For example, if the relying party is a financial institution, they may carry out their own authentication based on claimed location data that they store, and verified location data received from the verifying party. The relying party may therefore be the authenticating party in many embodiments.

### Secure Distribution Networks

Geodetic authentication can be used to improve data security in online information transactions. Most practical electronic distribution networks are exposed to security threats because they exploit widespread communication infrastructure (such as the internet and cellular network) to distribute information. The underlying infrastructure enables information to be distributed to a significant portion of the general population at the expense of compromised security. Sensitive information (such as personal information, account pin numbers and passwords) is typically not transmitted digitally because of perceived exposure to security threats.

Geodetic authentication can be incorporated into information exchanges that exploit widespread digital distribution networks to address some security concerns (such as interception of sensitive information by a third party). Ideally, geodetic authentication is integrated with other security provisions to address a broad range of security threats. Sequential security implementations that require each stage of authentication to be satisfied before progressing to a subsequent stage may be implemented for sensitive data transmissions. This produces greater data security than a segregated approach where security provisions are implemented in isolation.

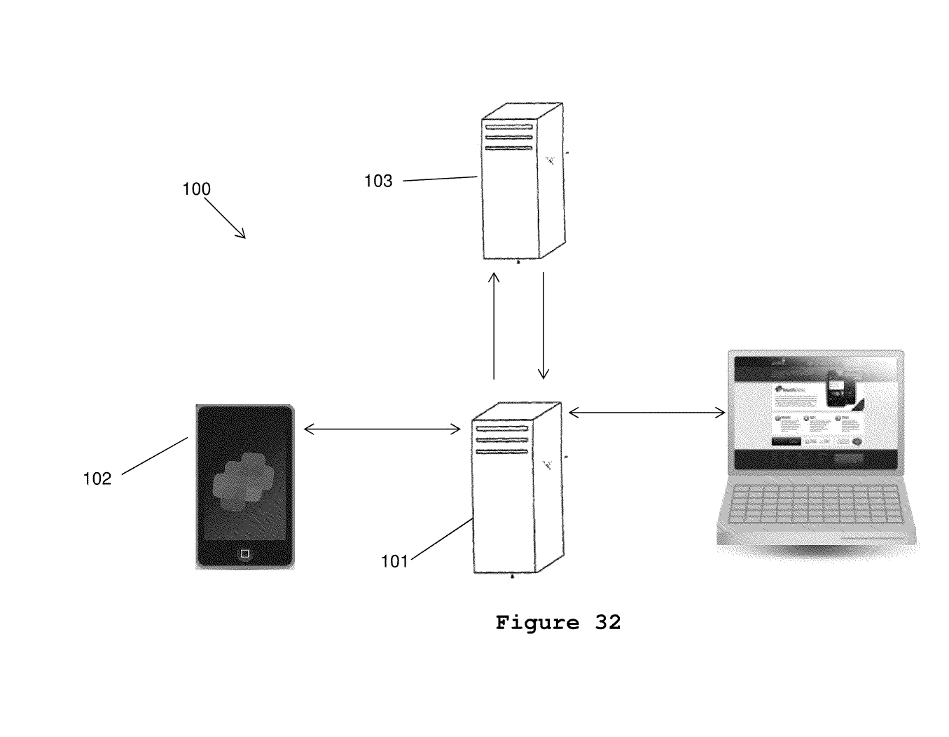

A data distribution network is illustrated in FIG. 32. The distribution network 100 comprises a distribution server 101 that interfaces with a plurality of client systems 102 to exchange data. The distribution server 101 is connected to a data network that facilitates communication with the client systems. The data network typically includes a third party communications backbone (such as a cellular network or broadband infrastructure).

The functional components of the distribution server 101 may be implemented in any suitable computing architecture, such as a cloud based system, a virtual machine operating on shared hardware, a dedicated hardware machine or a server bank of connected hardware and/or virtual machines. The term ‘server’ in this specification represents general computing system functionality and is not limited to a particular type of hardware architecture.

The function of individual clients systems 102 may similarly be implemented be a range of computing architecture. Ideally, the client system architecture 102 has integrated geodetic components that facilitate determination of geospatial position. However, this functionality may be facilitating by auxiliary peripherals. Typical client systems include cellular phones, tablet computers, laptops and desktops. The term ‘client’ in this specification represents general computing system functionality and is not limited to a particular type of hardware architecture.

### Data Distribution Network Management

The distribution server 101 manages data exchanges within the data network. The server 101 receives data requests from the client systems 102 and distributes data parcels within the distribution network. The data requests are transmitted to the distribution server 101 from registered client systems 102.

Each data requests typically includes an account identifier that the distribution server references to a registered client account with associated security data. The distribution server 101 then processes the data request and transmits a response to a registered client system (either the system that issued the request or another system registered to the client account).

The distribution network can be implemented by institutions to transfer sensitive information to their customers. An exemplary application of the distribution network 100 is the delivery of pin codes or passwords from financial institutions to customers.

The automated data distribution process disclosed in this specification may be implemented by retail banks to reduce the overheads associated with bank card pin code distribution. Pin codes are conventionally distributed to customers by post. The distribution method disclosed in this specification maintains the geospatial security component of the postal process and reduces the chances of third party interception at reduced cost.

The distribution server 101 implements a security protocol for the delivery of data within the distribution network. The security protocol defines several steps that the distribution server 101 implements before delivering data to a client system. The steps include:
receiving a delivery request (accompanied by a client account identifier) from a client system 102,
retrieving a registered delivery location for a corresponding client account,
deriving a geospatial delivery reference that defines a bounding area containing the delivery location,
generating a delivery verification tag 117 by irreversibly encoding the geospatial delivery reference, and
assembling a data delivery parcel 115 comprising an encrypted data package 116 (typically the data requested by the client system) and a delivery verification tag 117 for the client account.

The distribution server 101 manages implementation of the security protocol for data deliveries. The individual phases of the delivery method can be executed by dedicated modules that interface with the distribution server (as described later in this specification). The client systems 102 also implement a local verification protocol that is compatible with the delivery protocol implemented by the distribution server 101. The client verification protocol is described later in this specification.

The illustrated distribution server 101 interfaces with an ancillary data server 103. The data server 103 stores media for distribution to the client systems 102(such as video, audio, passwords, pin numbers and tax codes). The distribution server 101 is disposed between the data server 103 and the client systems 102 so that information exchanges between the respective network nodes are co-ordinated by the distribution server 101.

The distribution server 101 and the data server 103 may be managed by different parties (such as a software security company and a bank) where the distribution network (or a component of the distribution network) is provided as a service. The distribution server 101 may also be integrated with the data server 103 and controlled by a single party (such as a bank).

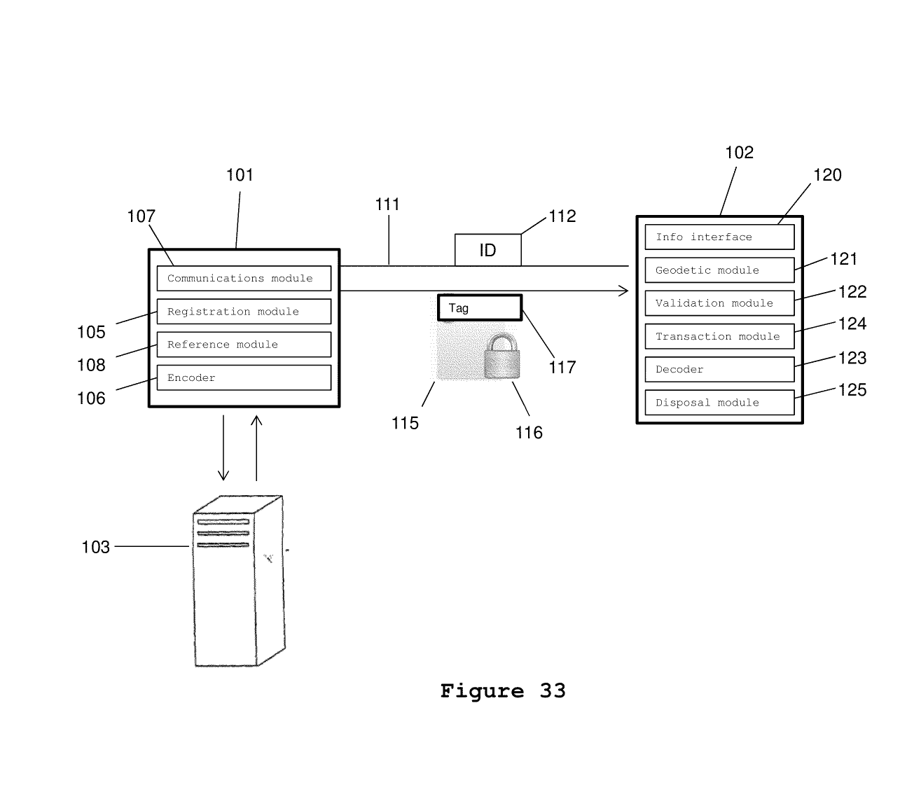

An information exchange between a client system 102 and the distribution server 102 is represented schematically in FIG. 33. The illustrated exchange is initiated by a client request 111 that is issued from the client system 102 to the distribution server 101. The request 111 is generated by an information interface 120 that is accessed through the client system 102. The information interface 120 manages communications with the distribution server 101 for the client system 102.

Each client request 111 includes an account identifier 112. The account identifier 112 designates a client account associated with the request 111. The distribution server 101 uses the account identifier to retrieve requested information from the data server 103.

The information interface 120 may request user input (such as manual entry of an account identifier) when generating a client request 111. Typical account identifiers include bank account numbers and usernames.

The client system 102 may automatically generate an account identifier if the system 102 is registered to a particular client account. Automatically generated account identifiers may incorporate information derived from the corresponding client system 102 (such as the system MAC address). Alternatively, the account identifier may incorporate an arbitrary token that is stored on the client system or an identifier that is derived from a corresponding client account (such as an account number or code) and retained locally on the client system.

The distribution server 101 maintains client accounts for the data distribution network. Each of the client accounts is linked to a client system and a registered delivery location. The distribution server 101 interfaces with the client systems 102 to distribute data within the distribution network.

The client systems 102 are linked to corresponding client accounts with a client system identifier. The client system identifier is ideally established when a client system is registered with the distribution network.

The registered delivery location associated with each client account defines a geospatial location for the receipt of information. The geospatial location may be defined by an absolute geospatial position (such as latitude/longitude co-ordinates or an equivalent GPS decimal representation) or a relative position that is referenced to a prescribed ‘landmark’.

The delivery location for a client account is typically selected by a user during an initiation process. The initiation process can be triggered by several events. Possible initiation events include:
the creation of a new client account with the distribution server,
the registration of a new client system with the distribution server, and
the installation of geodetic authentication software (such as an ‘app’ for a smart phone or generic computer system) on a client system.

The geospatial position of a client system during initiation is typically used to generate the new delivery location. The client software (operating on the client device) ideally prompts the user to position the client system proximate the intended delivery location during the initiation process to ensure the correct geospatial location is registered. Typical delivery locations coincide with a user's residential address or place of employment.

The link between the client accounts and the associated client data (the registered delivery location and client system identifier) enables the distribution server 101 to retrieve individual client security parameters that facilitate geodetic authentication. The information registered to each client account may be retained directly by the distribution server 101 or an auxiliary data server 103.

The distribution server 101 interfaces with a registration module 105. The registration module 105 is integrated with the distribution server 101 in the illustrated embodiment. The registration module 105 derives geospatial delivery references from the delivery locations linked to individual client accounts. Each geospatial delivery reference resolves the geospatial co-ordinates defined by a corresponding delivery location into a generalised bounding area that contains the delivery location.

The registration module 105 may derive the geospatial references from a spatial grid system. The spatial grid system defines a lattice that divides a geospatial area into a plurality of contiguous zones. The registration module 105 resolves the delivery location for a client account into an individual zone.

The perimeter of the zone containing the delivery location defines the outer confines of a corresponding bounding area. The registration module 105 can derive the geospatial reference for the bounding area from co-ordinates associated with the zone.

The size of the bounding area prescribed for information transactions is ideally configurable. This may be achieved by refining the resolution of the spatial grid. Factors that can influence the size of bounding area prescribed for an individual information transaction include:
the population density at the delivery location,
the sensitivity of the data being transmitted,
the delivery preferences associated with the client account settings, and
the security setting prescribed by the transmitting party.

Transactions involving sensitive information (such as bank account pin-code distributions) may be prescribed a relatively narrow bounding area for data receipt.

The distribution server 101 illustrated in FIG. 33 is interfaced with an encoder 106. The encoder 106 is integrated with the distribution server 101 in the illustrated embodiments. The encoder 106 encrypts outgoing data prior to transmission from the distribution server 101 to a client system 102. The outgoing data is ideally encrypted using a dedicated encryption key that is registered to a corresponding client account.

Individual client accounts may be linked to a dedicated encryption key. The dedicated encryption key is used by the encoder to encrypt information for a corresponding client account. The dedicated encryption keys (and corresponding decryption keys stored on the client systems) are ideally unique to a particular client system 102.

The encoder 106 uses the encryption key registered to a client account to encrypt a data package 116 for a target client system 102. The encrypted package 116 includes the information requested by the client system 102.

An individual client account may be linked to a plurality of registered client systems 102 (such as a user's mobile phone, laptop computer and tablet computer). Ideally, each client system is allocated a dedicated encryption key. However, the encryption key for an individual client account may be shared by each of the client systems registered to the account.

The distribution server 101 is also interfaced with a reference module 108. The reference module 108 generates delivery verification tags 117 from the geospatial delivery references generated by the registration module 105. The geospatial delivery references are passed from the registration module 105 to the reference module for encryption in verification tags 117. The reference module 108 is integrated with the distribution server 101 and directly interfaced to the registration module 105 in the illustrated embodiments.

The verification tags 117 generated by the reference module 108 are used by the client systems 102 to validate data deliveries. The reference module 108 generates the verification tags 117 by irreversibly encoding the geospatial delivery reference derived by the registration module 105. Each verification tag 117 is an encrypted representation of a geospatial delivery reference.

The encoding process implemented by the reference module 108 is ideally computationally impractical to reverse. There may be practical restrictions to the encoding process that make it theoretically possible to reverse (derive a geospatial delivery reference from the corresponding verification tag) at significant computational expense.

The reference module 108 may generate verification tags 117 by encoding the geospatial delivery reference using a one-way function. The one-way function produces a set of hash values that are cryptographically decoupled from the geospatial delivery reference. The geospatial reference for a data delivery cannot be derived from the corresponding verification tag 117.

The reference module 108 may combine the geospatial reference with a cryptographic salt before generating the verification tag 117. Obfuscating the geospatial reference with a cryptographic salt prior to the encoding procedure reinforces the verification tag 117 against brute force attacks. A dedicated cryptographic salt is ideally generated by the reference module 108 for each data transaction and transmitted to the corresponding client system 102.

The reference module 108 and the encoder 106 interface with a communications module 107. The communications module 107 receives data requests from the client systems 102 and distributes data from the distribution server 101. Most data deliveries are responsive to data requests received from client systems 102 (it is typically the client systems 102 that initiate data exchanges).

The communications module 107 assembles data parcels 115 for distribution to client systems 102 within the distribution network. Each data parcel 115 comprises an encrypted data package 116 (typically the data requested by the client system 102) and a delivery verification tag 117 for a corresponding client account. The communications module 107 receives the encrypted data package 116 and the verification tag 117 from the encoder 106 and reference module 108 respectively. The communications module 107 may also incorporate a dedicated cryptographic salt in the data parcel 115.

### Client Systems within the Data Distribution Network

The client systems 102 registered to the distribution network implement a verification process to validate data deliveries from the distribution server 101. The verification process evaluates the location of the client systems relative to the bounding area defined by the verification received with a data parcel 115.

The evaluation process executed by the client system compares encoded representations of the geospatial reference and the client system location to determine a proximity indicator. The encrypted package 116 is only release by the client system 102 is the proximity indicator satisfies defined decryption criteria.

The verification process implemented by each client system 102 defines several steps that are executed before the encrypted package 116 is released. The steps include:
obtaining a data parcel 115 comprising the encrypted package 116 and a corresponding verification tag 117,
determining the geospatial location of the client system 102 registered to the data parcel 115,
deriving a geospatial reference that defines a bounding area for the client system location,
generating a recipient authentication tag by irreversibly encoding the geospatial reference,
determining a correlation factor between the recipient authentication tag and the verification tag 117, and
decrypting the encrypted package 115 when the correlation factor indicates the client system is within a defined proximity of a registered delivery location.

The client systems 102 illustrated in FIG. 33 incorporate a geodetic module 121. The geodetic module 121 generates geospatial references for the client system 102. The geospatial references generated by the geodetic module 120 are derived from the geospatial location of the client system 102 at a defined time (usually when a delivery validation process is initiated).

The geodetic module 121 obtains the geospatial location of client systems 102 from an authenticated source. The source of geospatial data for individual client systems 102 may be adapted to reflect the capabilities of the corresponding systems 102. Typical sources include:
a GPS module associated with the client system 102,
a cellular network provider that determines the client system position from multilateration of cellular signals, and
a tracking module installed on the client system 102 that determines the system position from multilateration of wireless signals (typically cellular or wifi signals).

The geodetic module 121 obtains the geospatial location of a corresponding client system 102 and resolves the location into a bounding area. This process is co-ordinated with the registration module 105 to ensure that the recipient authentication tag generated by the client system 102 is compatible with the verification tag 117.

The registration module 105 and the geodetic module 121 may use an identical grid system to generate the respective geospatial references. The parameters of the spatial grid for each data delivery are ideally managed by the registration module 105. The geodetic module 121 and the registration module 105 can resort to a default grid setting in the absence of explicit grid parameters.

The geodetic module 121 locates the client system 102 within a spatial zone defined grid system. The perimeter of the zone defines the outer confines of a corresponding bounding area for the client system 102. The geodetic module 121 can derive the geospatial reference for the bounding area from co-ordinates associated with the zone.

The geodetic module 121 obtains a co-ordinate set defining the vertices the bounding area shares with adjacent areas of the geospatial grid. The bounding area shares some of the co-ordinates (corresponding the shared vertices) with the adjacent areas.

The geodetic module 121 is interfaced to a transaction module 124. The transaction module 124 generates recipient authentication tags for data deliveries. Each recipient authentication tags is irreversibly encoded from the geospatial location of a corresponding client system.

The transaction module 124 encrypts the client system location using an encoding process that is compatible with the reference module 108. The encoding process implemented by the transaction module 124 is ideally computationally impractical to reverse. There may be practical restrictions to the encoding process that make it theoretically possible to reverse (derive the client system location from the corresponding authentication tag) at significant computational expense.

Establishing sufficient compatibility between the respective modules 108, 124 usually involves using the same cryptographic process (function or combination of functions) to encrypt the authentication tags and the verification tags 117. The reference module 108 and the transaction module 124 produce matching outputs for the same geospatial reference. The authentication tag and verification tag 117 are ideally identical for geospatial locations within the same bounding area.

Geospatial locations disposed in adjacent bounding areas produce defined correlations between the authentication tag and verification tag 117. It may be possible to determine the relative position of the respective geospatial locations from the tag correlations (such as above-and-below, side-by-side or diagonally-offset).

The output from the reference module 108 and the transaction module 124 can be co-ordinated using a standardised geospatial grid system and identical encoding procedure (such as replicated one-way functions). The encoded co-ordinates derived from the grid system can then be compared to determine the proximity of the client system to the delivery address without exposing the respective geospatial positions. This involves comparing the hash value sets produced by the reference module 108 and the transaction module 124 for encoding procedures incorporating replicated one-way functions.

The transaction module 124 also replicates any salting process implemented by the reference module 124. Dedicated cryptographic salts used by the reference module 108 to encode a verification tag 117 are distributed to the transaction module of a corresponding client system 102 by the communications module 107. The communications module 107 ideally transmits the relevant salt values to the client system 102 with the data parcel 115.

An information interface 120 associated with the client systems 102 retrieves the dedicated cryptographic salts. The information interface 120 passes the cryptographic salt to the transaction module 124 for combination with a geospatial reference generated by the client system. The geospatial reference and the cryptographic salt are combined prior to encoding the authentication tag. The information interface 120 transmits delivery requests to the distribution server 102 and receives the data parcels 115 transmitted to the client system 102. The delivery requests generated by the information interface 120 incorporate an account identifier that the distribution server 101 (or an associated data server) uses to register the request to a client account.

The information interface 120 also manages data deliveries received from the distribution server 101. The data parcels 115 are divided into individual components (typically an encrypted package 116, verification tag 117 and cryptographic salt) for distribution to corresponding modules associated with the client system 102.

The verification tag 117 is transferred to a validation module 122. The validation module 122 authenticates data deliveries from the distribution server 101 by comparing the verification tag 117 to the authentication tag generated by the transaction module 124. The validation process identifies correlations between the verification tag 117 and the authentication tag that indicate the client system 102 is proximate the delivery location.

Data deliveries are authenticated when the correlation factor derived from an authentication tag and verification tag 117 satisfies a proximity criteria associated with the corresponding data parcel 115. Possible proximity correlations include:
Coincident—the client system 102 is contained within the bounding area defined by the verification tag 117.
Adjacent—the client system 102 is contained within a bounding area that is adjacent to the bounding area defined by the verification tag 117.
Uncorrelated—the bounding area containing the client system does not share any co-ordinates with the bounding area containing the delivery location.

The encrypted data package 116 is transferred to a decoder 123 if the data parcel proximity criteria is satisfied. The decoder 123 has access to a dedicated decryption key stored on the client system 102. The dedicated decryption key is cryptographically related to a dedicated encryption (stored in the registration module 105) that is used to encrypt the data package 116.

The decoder 123 retrieves the decryption key and decrypts the data package 115 following authentication of the data delivery. The validation module 122 prevents the data package 116 from being decrypted if the derived correlation factor does not satisfy the proximity criteria for the data delivery.

The encrypted data package 116 may be discarded if the corresponding data delivery is not authenticated or other delivery criteria are not satisfied. The illustrated client system 102 incorporates a disposal module 125 that is responsible for discarding the encrypted data package 116.

Ideally, the distribution server 101 defines conditions for managing a data package 116 transmitted to client systems 102. The distribution server 101 may encode the data parcel 115 with usage information that defines how the parcel 115 is handled or modify the validation module 122 settings by initiating software updates for the client system 102. Situations that can potentially initiate deletion of a data package include:
exceeding a limit for unsuccessful data delivery authentication attempts,
exceeding a decryption time limit that is initiated by receipt of a data delivery, or
exceeding a usage time limit following decryption of the package 116.

The disposal module 125 may also discard the decrypted data after it has been accessed by the client system 102 to avoid creating a trail of sensitive information. The disposal module 125 ideally discards decrypted data immediately after it has been accessed by the client system 102.

### Data Distribution Process

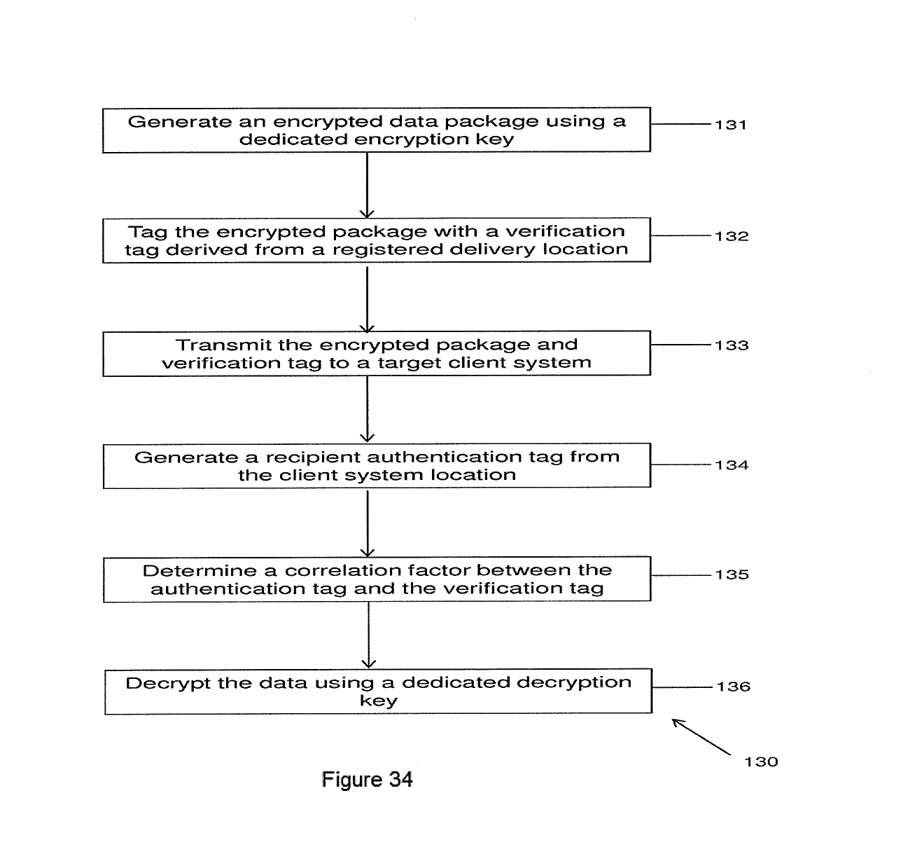

A data distribution process that the distribution network 100 may employ is summarised in the flow chart 130 presented in FIG. 34. The first operation 131 depicted in the flow chart is the generation of an encrypted data package. Data is encrypted with a dedicated encryption key that is registered to a client account for a target client system 102. This is typically performed by the encoder 106.

The encryption process is typically initiated by receipt of a client request (not shown in the flow chart 130 presented in FIG. 34). The client request is issued by a client system 102 and identifies a corresponding client account. The client system 102 may be registered to the client account maintained by the distribution server 101. The registration process involves storing a system identifier for the client system and linking the system identifier to the corresponding client account.

The distribution server 101 retrieves client information from the client account following the client request. The client information includes a dedicated decryption key that is used to encrypt the requested data. The client information is used to prepare a data delivery for the client system 102.

The encrypted package 116 is tagged with a verification tag 117 in the next operation 132 depicted in the flow chart 130. This is typically performed by the communications modules 107 during assembly of a data parcel 115. The verification tag is produced from a delivery location registered to the client account. The encrypted information and accompanying verification tag are transmitted to a client system 102 (depicted in operation 133 of the flow chart 130).

The client system 102 authenticates each data delivery before the associated data package 115 is decrypted. Delivery authentication is initiated by the client system 102 following receipt of the data parcel 115.

The client system 102 generates a recipient authentication tag (depicted in operation 134 of the flow chart 130) for comparison with the delivery verification tag 117. The recipient authentication tag is derived from the geospatial location of the client system when the authentication process is initiated.

The client system 102 determines a correlation factor between the generated authentication tag and the received verification tag (represented by operation 135 of the flow chart 130). The correlation factor represents the proximity of the client system to the registered delivery location. The data delivery is authenticated if the correlation factor indicates that the client system is within a defined proximity of the registered delivery location (depicted in operation 136 of flow chart 130).

The data package 116 is decrypted following successful authentication of the client request. A decoder 123 performs the decryption process using a dedicated decryption key that is stored on the client system. The decryption key is cryptographically related to an encryption used by the encoder 106 to encrypt the information.

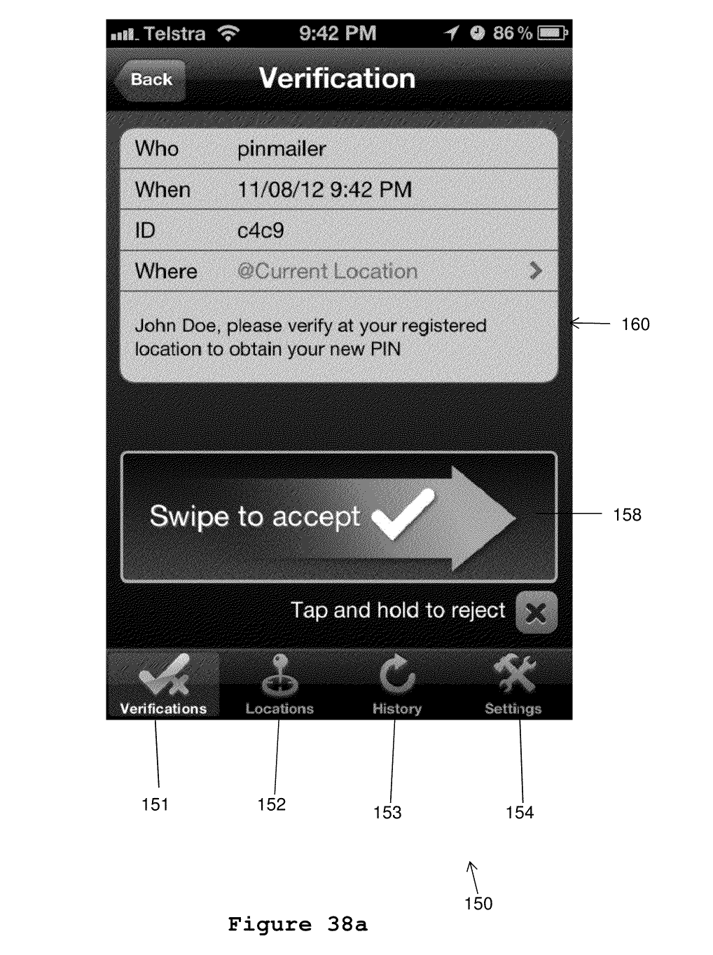

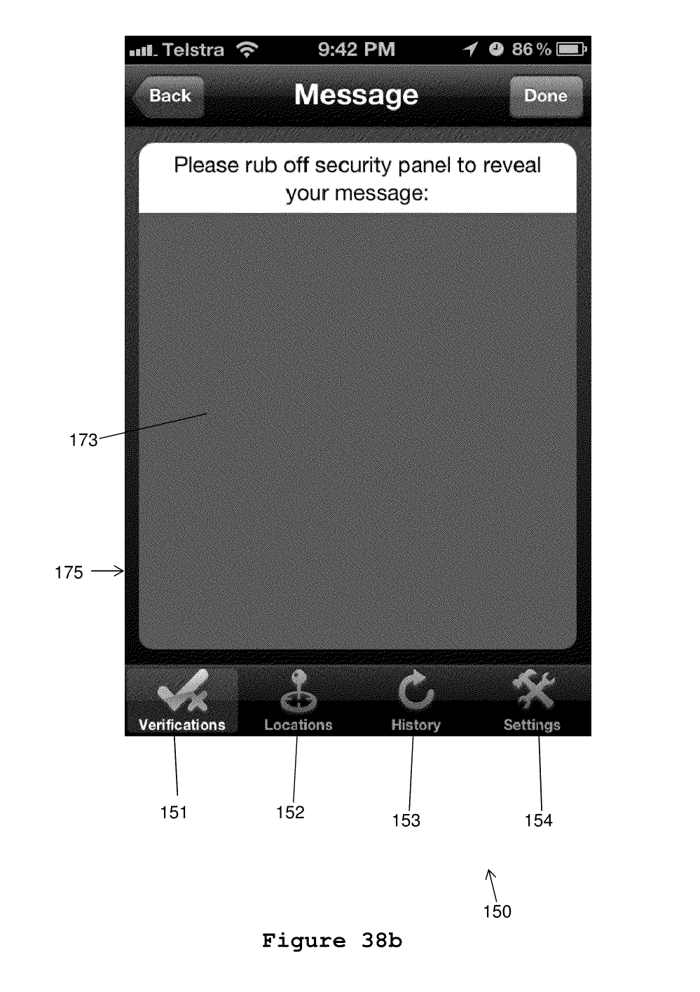

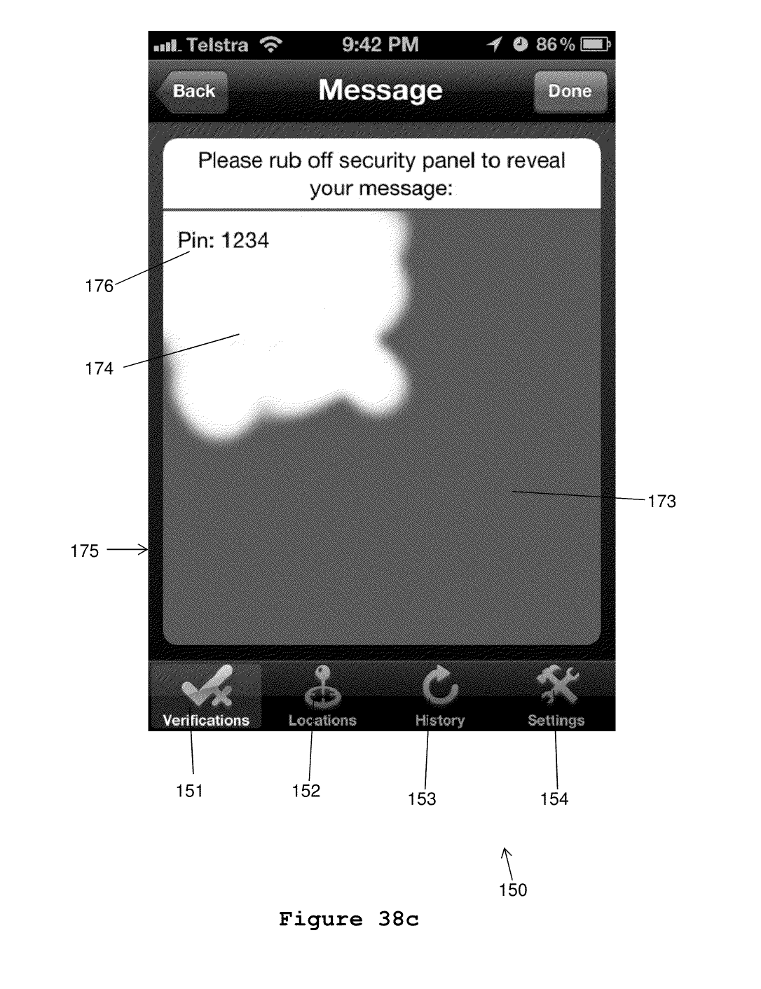

The decrypted data package 116 is ideally presented in a user interface that avoids inadvertent exposure of the information. One interface 175 that may be used to convey the account information to a user is presented in FIGS. 38a and 38b. The interface comprises a ‘virtual scratch panel’ 173 that requires prolonged cumulative user interaction to reveal the decrypted data.

The decrypted data is initially ‘covered’ by the virtual scratch panel 173 (as illustrated in FIG. 38b). The user interface 175 requires definitive user interaction to ‘rub off’ a section of the scratch panel 173 ‘covering’ the account information.

A user is required to maintain prolonged contact with the scratch panel interface 175 and move the ‘point of contact’ with the interface across the sections of the panel 173 that they want to remove. The cumulative effect of the user's interaction is presented in FIG. 38c. An upper left section 174 of the scratch panel has been removed to reveal the ‘underlying’ content 174 of the interface 175.

The ‘point of contact’ with the scratch panel interface 175 is defined by the user through a corresponding client system 102. The capabilities of the client system ultimately define the mechanism that is used to determine the ‘point of contact’. For touch enabled systems (such as smartphones or tablet computers), the ‘point of contact’ is ideally the physical contact point between the user and the touch surface (such as a touch screen). For conventional computing system, the ‘point of contact may be the position of the mouse on a corresponding screen when a trigger is depressed (such as a mouse button).

The data delivery process implemented by the client system 102 depicted in FIGS. 38a to 38b is summarised in the following operations:
obtaining display co-ordinates for the presentation of data on a computing system interface, the display co-ordinates defining the position of the data on the interface,
displaying a block image on a continuous section of a computing system interface that encompasses the position defined by the display co-ordinates, the block image representing a virtual panel that obscures underlying data,
receiving user input that coincides with the position of the data defined by the display co-ordinates and removing sections of the block image from the computing system interface that coincide with the received user input, and
displaying portions of the data that coincide with the removed sections of the block image to give the impression of the data being revealed from underneath the panel by the user input.

The decrypted account data is ideally discarded after being accessed by the client system 102. A disposal module 125 integrated with the client system 102 eradicates the decrypted data after it has been accessed to avoid creating a trail of sensitive information. The disposal module 125 ideally discards the data immediately after it has been accessed by the client system 102.

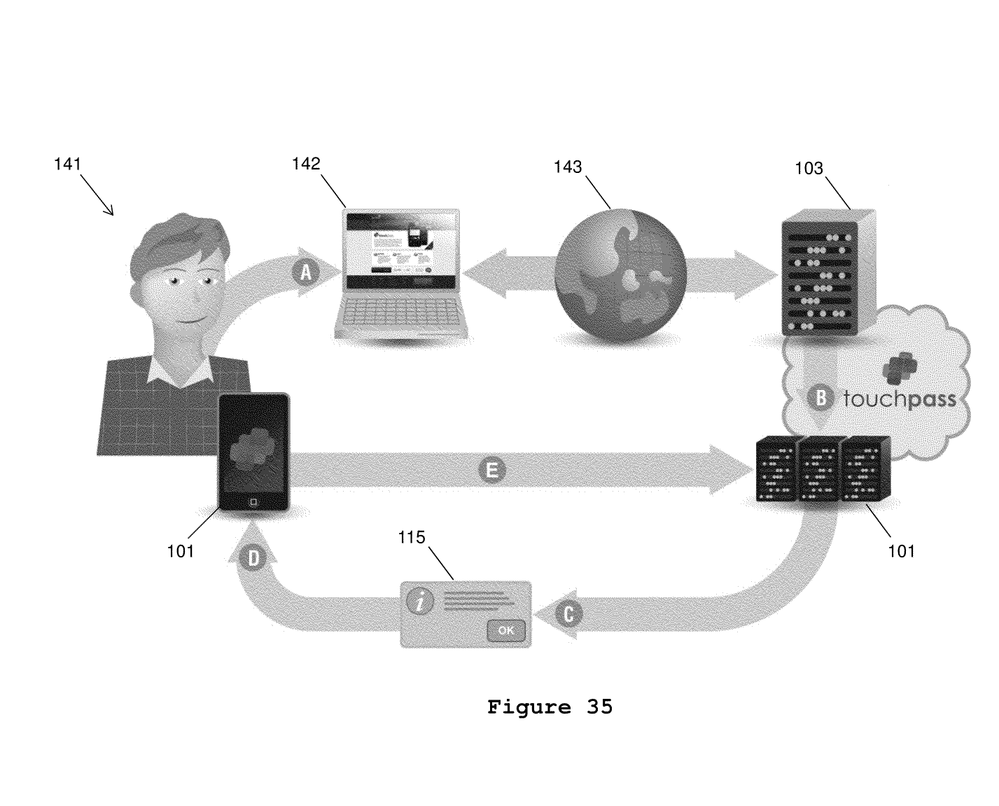

A client system 102 registration process is illustrated in FIG. 35. The process 140 is initiated by a user 141. The user 141 initiates the process by logging on to a data server 103 and submitting a registration request. The registration request includes a system identifier for a client system that a user wants to register (such as a mobile phone).

The user 141 utilises an auxiliary computing system 142 to access the data server 103 in the illustrated embodiment. The data server 103 is connected to a data network 143 that facilitates communication with the auxiliary computing system 142. The registration request is transmitted across the data network 143 to the data server 103.

The data server 103 processes the registration request. The system identifier (submitted with the registration request) and an account identifier are transferred to a distribution server 101. The distribution server 101 registers the client system in a registration module 105 and generates an authentication request 115. The authentication request 115 is sent to the client system 102.

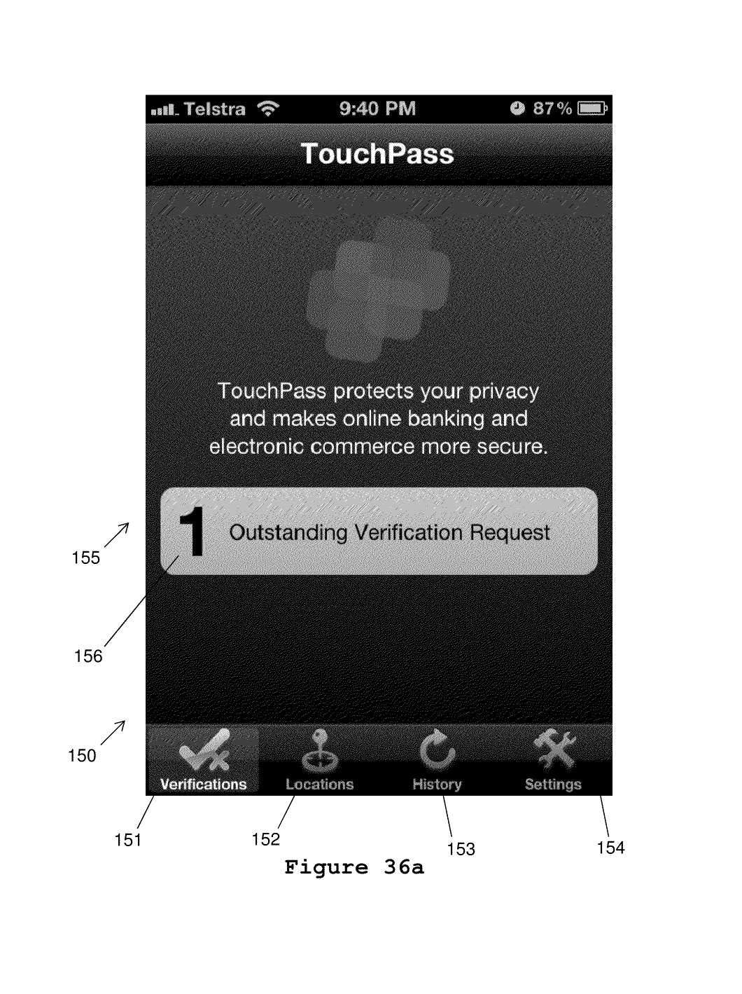

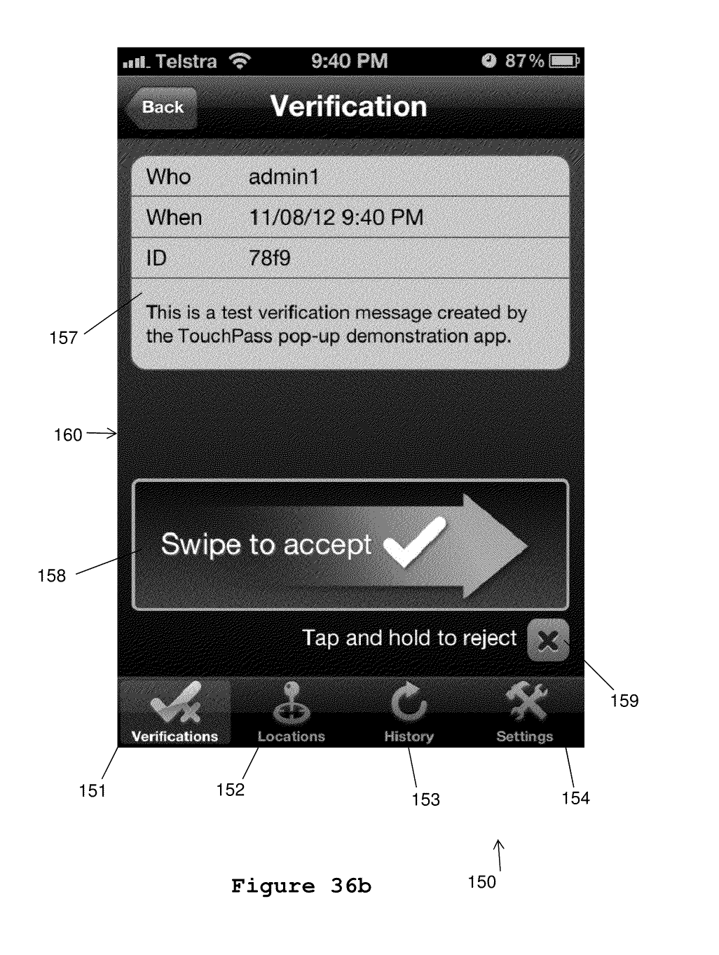

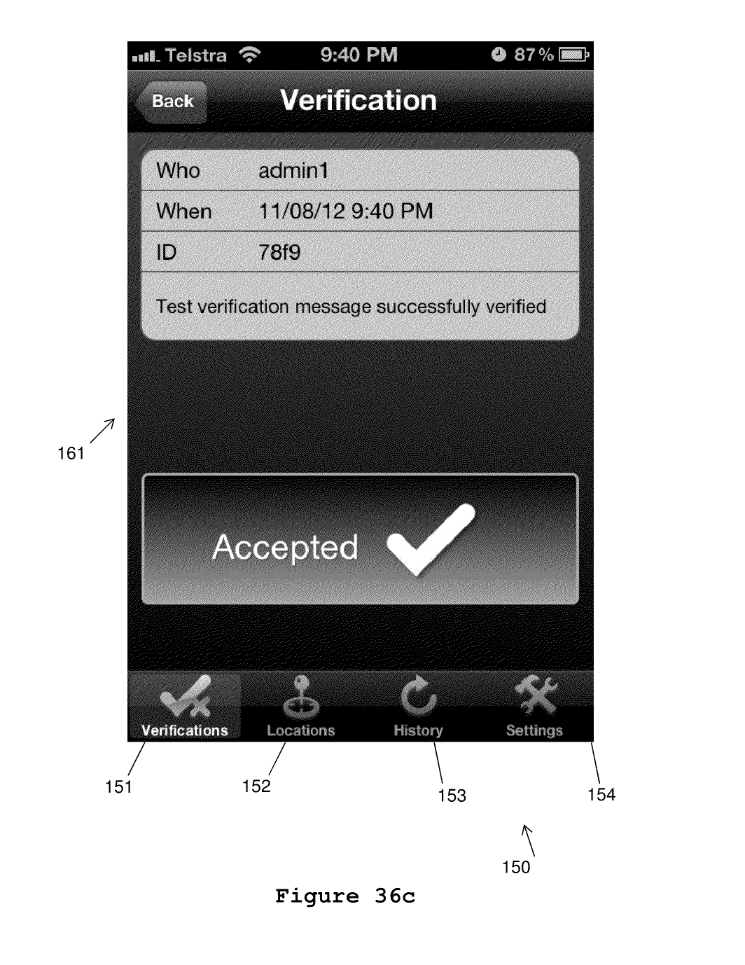

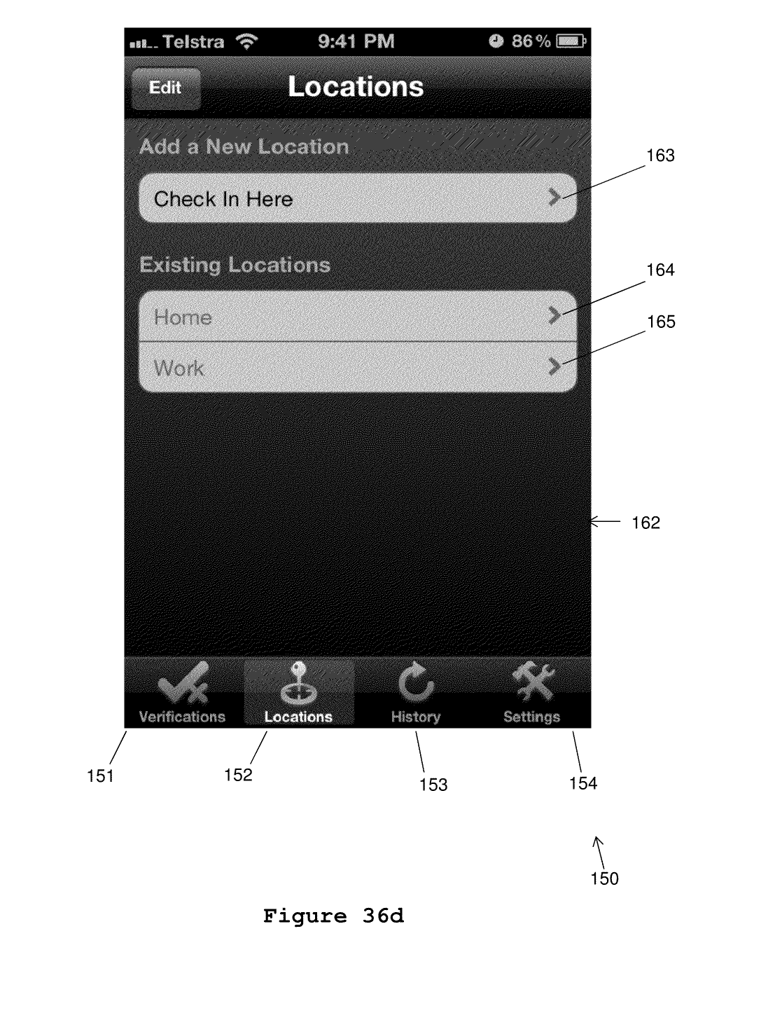

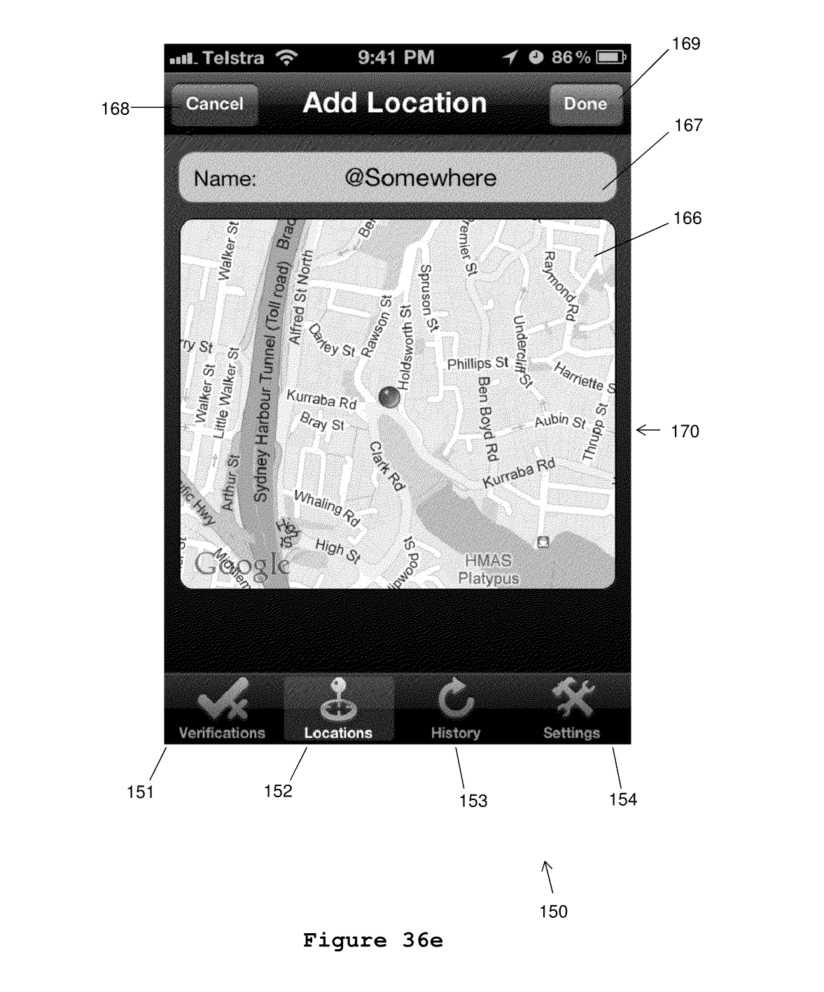

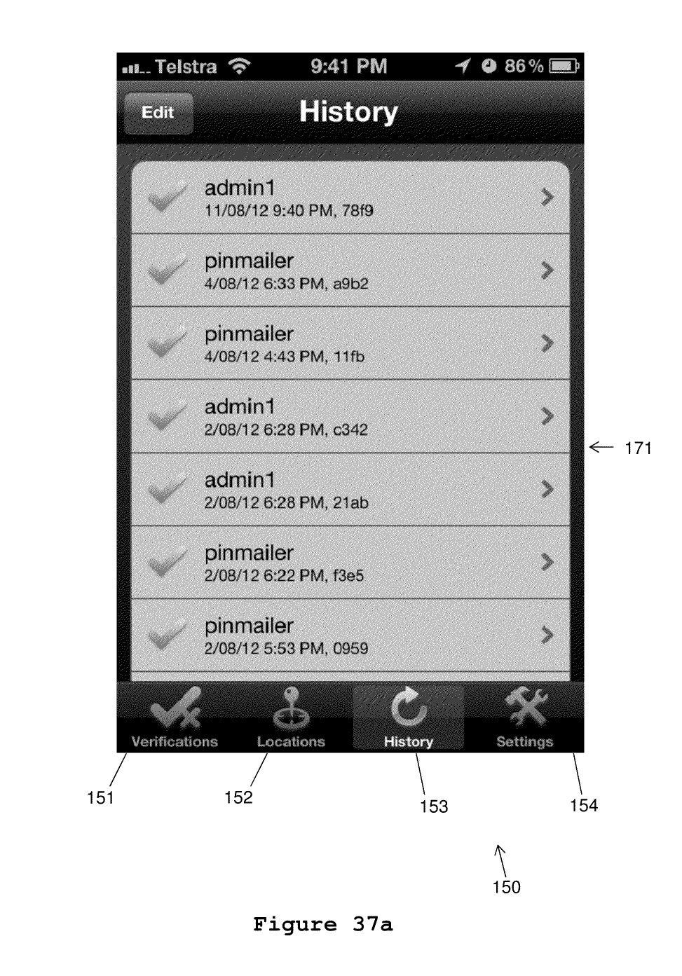

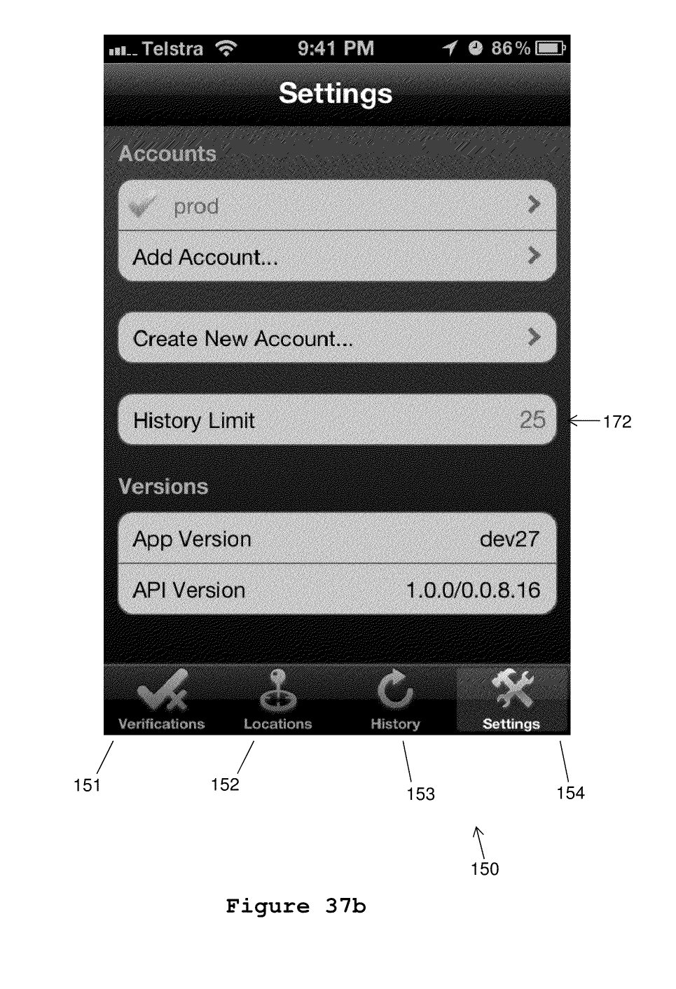

The user 141 completes a device registration process on the client system 102 to verify the registration request. A collection of screenshots for a device registration process are presented in FIGS. 36a to 36e. The screenshots depict a user interface 150 that facilitates user interaction. The illustrated interface 150 has four interface modules. The interface modules are presented as ‘tabs’ that are arranged along the lower edge of the screen. The illustrated tabs are:

Verifications 151

Locations 152

History 153

Settings 154

The device registration process initiates with a notification screen 155 that alerts the user 141 to an outstanding verification request. The notification screen 155 is presented in FIG. 36a. The user 141 acknowledges the request and progresses to the next screen by pressing a confirmation interface 156.

A request verification screen 160 is presented to the user 141 following the notification screen. The request verification screen 160 is illustrated in FIG. 36b. A notification section 157 of the screen 160 explains the verification request and documents various request attributes (such as ‘who’ generated the request, ‘when’ the request was generated and an ‘ID’ for the request). The verification screen 160 prompts a user to initiate the verification process. A user is presented with an acceptance interface 158 (labelled ‘swipe to accept’) and a rejection interface 159 that enables the user 141 to address the request.

A confirmation screen 161 is illustrated in FIG. 36c. The confirmation screen 161 is presented to the user 141 if they accept the verification request presented on the previous screen 160. The confirmation screen 161 displays feedback to the user 141 that their acceptance of the verification request has been processed.

The user 141 is presented with a location screen 162 that facilitates registration of a verified geospatial decryption location. The location screen 162 is illustrated in FIG. 36d. Two existing verified locations (‘home’ 164 and ‘work’ 165) are depicted on the illustrated location screen 162. The location screen 162 also includes a new location interface 163 that a user 141 engages to register a geospatial location. The new location interface transfers the user 141 to a location confirmation screen 170.

The location confirmation screen 170 is illustrated in FIG. 36e. The screen 170 displays a map 166 of the client system's current geospatial location. The user 141 can tag the new location by adding a location ‘name’ in a prescribed text field 167. The screen 170 also incorporates a confirmation interface (‘done’) and an escape interface (‘cancel’).

The client system 102 transmits confirmation that the user 141 has completed the registration process to the distribution server 101 and registers the verified geospatial location(s) with the registration module 105.

The ‘history’ module screen 171 and the ‘settings’ module screens 172 are illustrated in FIGS. 37a and 37b respectively. The ‘history’ module 153 enables a user to track their interactions with the distribution server 101. The ‘settings’ module 154 allows a user to manage the client system interface 150.

A collection of user interface screens that a client system may display during validation of a secure packet are presented in FIGS. 38a to 38c. The client system 102 displays a request verification screen 160 following receipt of a secure packet 115. The format and function of the request verification screen 115 is ideally the same as the screen depicted in FIG. 36b. The interface 160 prompts a user to initiate the verification process. A user accepts the request by engaging the acceptance interface 158.

The user interface 150 displays a virtual scratch panel 173 following successful validation of a client request (illustrated in FIG. 38b). The virtual scratch panel 173 covers the decrypted content derived from the secure packet 115. A user is prompted to ‘rub off’ the sections of the panel to reveal the decrypted information (as illustrated in FIG. 38c). The prolonged cumulative interaction required from the user to remove the scratch panel reduces inadvertent exposure of the decrypted information to another party.

Embodiments of the invention described above may be implemented partly by computer programs. Where they are implemented by computer programs, the computer programs may be provided on-line, by transportable memory, such as disc or USB, as a data signal, or in any other way.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood to persons skilled in the art of the invention that many modifications may be made without departing from the spirit and scope of the invention.

1. A data delivery method comprising:
receiving a delivery request from a client system, the request including a client account identifier,
retrieving a registered delivery location for a corresponding client account, the delivery location prescribing a geospatial position for recipient verification,
deriving a geospatial delivery reference from the delivery location, the geospatial delivery reference defining a bounding area that contains the delivery location,
generating a delivery verification tag from the geospatial delivery reference, the verification tag being an irreversible encoding of the geospatial delivery reference, and
assembling a data delivery parcel comprising an encrypted data package and a delivery verification tag.

2. The method of claim 1 comprising encoding the geospatial delivery reference using a one-way function to cryptographically decouple the verification tag from the geospatial delivery reference.

3. The method of claim 1 comprising retrieving a dedicated encryption key registered to a corresponding client account for a target client system and using the dedicated encryption to encrypt a data package.

4. The method of claim 1 comprising generating a dedicated cryptographic salt for the received delivery requests and combining the geospatial delivery reference with the dedicated cryptographic salt prior to generating the delivery verification tag.

5. The method of claim 4 comprising incorporating the dedicated cryptographic salt in the data delivery parcel with the verification tag and the encrypted data package.

6. The method of claim 1 comprising transmitting the data delivery parcel to the client system responsible for the delivery request.

7. The method of claim 1 comprising transmitting the data delivery parcel to a client system registered to the corresponding client account.

8. A verification process comprising:
obtaining a registered data parcel comprising an encrypted package and a verification tag,
determining the geospatial location of a client system registered to the data parcel,
deriving a geospatial reference from the client system location, the geospatial reference defining a bounding area that contains the determined location of the client system,
generating a recipient authentication tag from the geospatial reference, the authentication tag being an irreversible encoding of the geospatial reference,
determining a correlation factor between the recipient authentication tag generated for the client system and the verification tag incorporated in the data parcel, and
decrypting the encrypted package when the correlation factor indicates the client system is within a defined proximity of a registered delivery location.

9. The method of claim 8 comprising encoding the geospatial reference using a one-way function to cryptographically decouple the recipient authentication tag from the geospatial reference.

10. The method of claim 8 comprising retrieving a dedicated decryption key registered to the client system and using the dedicated decryption to decrypt a data package.

11. The method of claim 8 comprising retrieving a dedicated cryptographic salt incorporated in the registered data parcel and combining the geospatial reference with the dedicated cryptographic salt prior to generating the recipient authentication tag.

12. The method of claim 8 comprising transmitting a delivery request from a registered client system and receiving the data parcel in response to the request, the request including a client account identifier that the client system is registered against.

13. The method of claim 8 comprising automatically discarding the encrypted package after the data parcel has been accessed by the client system.

14. The method of claim 8 comprising covering information decrypted from the data parcel with a virtual scratch panel that requires cumulative user input to reveal the decrypted information.

15. The method of claim 8 comprising locating the client system within a defined spatial grid and deriving the geospatial reference for the client system from the grid co-ordinates of the bounding area that contains the client system.

16. The method of claim 15 comprising obtaining a co-ordinate set defining the vertices of the bounding area that are shared with adjacent areas of the geospatial grid and encoding the individual co-ordinates using a one-way function to generate the recipient authentication tag for the client system.

17. A data delivery system comprising:
a distribution server that maintains client accounts for a data distribution network and interfaces with a plurality of client systems, each of the client accounts being linked to a client system and a registered delivery location,
a registration module that derives geospatial delivery references from the delivery locations linked to individual client accounts, the geospatial delivery references defining a bounding area that contains a corresponding delivery location,
a reference module that generates verification tags for data deliveries, each of the verification tags being irreversibly encoded from the geospatial delivery reference derived for a target client account, and
a communications module that assembles data parcels for distribution to client systems within the distribution network, each data parcel comprising an encrypted data package and a delivery verification tag for a corresponding client account.

18. The system of claim 17 comprising an encoder that encrypts data packages for target client systems using a dedicated encryption key registered to a corresponding client account.

19. The system of claim 17 comprising a geodetic module that derives geospatial area references from the geospatial location of client systems, the geospatial area references defining a bounding area that contains the current geospatial location of a corresponding client system.

20. The system of claim 19 comprising a transaction module that generates authentication tags for data deliveries, each of the authentication tags being irreversibly encoded from the location of a corresponding client system using an encoding process that is compatible with the reference module

21. The system of claim 20 comprising a validation module that compares client authentication tags to delivery verification tags to verify that a client system is within a defined proximity of the registered delivery location for a corresponding client account.

22. The system of claim 21 comprising a decoder associated with each of the client systems that decrypts the encrypted package received from the distribution server when the client system is within a defined proximity of a registered delivery location, the decoder using a dedicated decryption key stored on the client system that is cryptographically related to a dedicated encryption used by the registration module for a corresponding client account.

23. A recipient verification method comprising comparing an irreversibly encoded geospatial decryption reference accompanying a digital delivery to a current recipient system location irreversibly encoded using a compatible encoding process to verify the recipient system before releasing an encrypted data package.

24. A data delivery process comprising:
obtaining display co-ordinates for the presentation of data on a computing system interface, the display co-ordinates defining the position of the data on the interface,
displaying a block image on a continuous section of a computing system interface that encompasses the position defined by the display co-ordinates, the block image representing a virtual panel that obscures underlying data,
receiving user input that coincides with the position of the data defined by the display co-ordinates and removing sections of the block image from the computing system interface that coincide with the received user input, and
displaying portions of the data that coincide with the removed sections of the block image to give the impression of the data being revealed from underneath the panel by the user input.

25. The method of claim 37 comprising discarding the data after the data has been displayed on the computing system interface.

26. An non-transitory computer readable medium with instructions that cause a computing system to execute the method of claim 1.

27. An non-transitory computer readable medium with instructions that cause a computing system to execute the process of claim 8.

28. An non-transitory computer readable medium with instructions that cause a computing system to execute the process of claim 24.
